(19) United States
(12) Patent Application Publication
(10) Pub. No.: US 2022/0335358 A1
(43) Pub. Date: Oct. 20, 2022

(54) STORE SUPPORTING SYSTEM, LEARNING DEVICE, STORE SUPPORTING METHOD, GENERATION METHOD OF LEARNED MODEL, AND PROGRAM

(71) Applicant: PANASONIC INTELLECTUAL PROPERTY MANAGEMENT CO., LTD., Osaka (JP)

(72) Inventors: Junya YAMAMOTO, Tokyo (JP); Takahiro SUGIMOTO, Tokyo (JP); Masataka EJIMA, Chiba (JP)

(73) Assignee: PANASONIC INTELLECTUAL PROPERTY MANAGEMENT CO., LTD., Osaka (JP)

(21) Appl. No.: 17/764,867

(22) PCT Filed: Sep. 1, 2020
(86) PCT No.: PCT/JP2020/033049

§ 371 Date: Mar. 29, 2022

(30) Foreign Application Priority Data
Oct. 3, 2019 (JP) 2019-183218

(51) Int. Cl. G06Q 10/06; G06Q 30/02; G06N 5/02

(52) U.S. Cl. CPC G06Q 10/06393; G06Q 30/0204; G06N 5/022

(57) ABSTRACT

A store supporting system includes an estimation unit and an output unit. The estimation unit is configured to estimate, based on a learned model, a management index by using at least operation information as input information. The operation information is information on operation of a target store which is a specific store. The management index is an index relating to management of the target store. The learned model is generated by machine learning with data, as training data, including information on operation of a store and an index relating to management of the store. The output unit is configured to obtain, based on a result of estimation by the estimation unit, recommendation information and output the recommendation information. The recommendation information is information relating to the operation of the target store and is recommendable for the target store.

### TECHNICAL FIELD

The present disclosure generally relates to store supporting systems, learning devices, store supporting methods, generation methods of learned models, and programs. The present disclosure specifically relates to a store supporting system, a learning device, a store supporting method, a generation method of a learned model, and a program for supporting operation of a target store which is a specific store.

### BACKGROUND ART

Patent Literature 1 describes a product lineup recommendation device configured to determine a recommended product lineup, in a business form in which a large number of stores are managed on the headquarters side, in order to increase the sales through stock management of appropriate products.

The product lineup recommendation device described in Patent Literature 1 calculates, on the basis of sales results for the target store during a predetermined past time period, first configuration information which is sales monetary amount configuration information for products having sales results at the target store. Moreover, the product lineup recommendation device calculates, on the basis of a prediction model that predicts sales monetary amount configuration information for single product items, second configuration information which is sales monetary amount configuration information for products having no sales results at the target store during the period. The product lineup recommendation device selects a specified number of products from among products for which the first configuration information is calculated and products for which the second configuration information is calculated, in descending order of monetary amount indicated by the sales monetary amount configuration information.

In the product lineup recommendation device described in Patent Literature 1, the product lineup to be recommended for the target store is determined mainly on the basis of the past sales results for the target store, and therefore, situations of the other stores are not satisfactorily utilized, and properly supporting the operation of the target store is thus difficult.

### CITATION LIST

### Patent Literature

Patent Literature 1: WO2018/056220 A1

### SUMMARY OF INVENTION

In view of the foregoing, it is an object of the present disclosure to provide a store supporting system, a learning device, a store supporting method, a generation method of a learned model, and a program which are configured to easily properly support operation of a target store.

A store supporting system according to an aspect of the present disclosure includes an estimation unit and an output unit. The estimation unit is configured to estimate, based on a learned model, a management index by using at least operation information as input information. The operation information is information on operation of a target store which is a specific store. The management index is an index relating to management of the target store. The learned model is generated by machine learning with data, as training data, including information on operation of a store and an index relating to management of the store. The output unit is configured to obtain, based on a result of estimation by the estimation unit, recommendation information and output the recommendation information. The recommendation information is information relating to the operation of the target store and is recommendable for the target store.

A learning device according to an aspect of the present disclosure is configured to generate a learned model to be used in a store supporting system. The store supporting system is configured to estimate a management index by using at least operation information as input information. The operation information is information on operation of a target store which is a specific store. The management index is an index relating to management of the target store. The learning device is configured to generate the learned model by machine learning with data which is input as training data to the learning device and which includes information on operation of a store and an index relating to management of the store.

A store supporting method according to an aspect of the present disclosure includes an estimation process and an output process. The estimation process is a process of estimating, based on a learned model, a management index by using at least operation information as input information. The operation information is information on operation of a target store which is a specific store. The management index is an index relating to management of the target store. The learned model is generated by machine learning with data, as training data, including information on operation of a store and an index relating to management of the store. The output process is a process of obtaining, based on a result of estimation by the estimation process, recommendation information and outputting the recommendation information. The recommendation information is information relating to the operation of the target store and is recommendable for the target store.

A generation method of a learned model according to an aspect of the present disclosure is a generation method of the learned model to be used in a store supporting system. The store supporting system is configured to estimate a management index by using at least operation information as input information. The operation information is information on operation of a target store which is a specific store. The management index is an index relating to management of the target store. The generation method of the learned model includes generating the learned model by machine learning with data which is input as training data and which includes information on operation of a store and an index relating to management of the store.

A program according to an aspect of the present disclosure is a program configured to cause one or more processors to execute the store supporting method or the generation method of the learned model.

### BRIEF DESCRIPTION OF DRAWINGS

FIG. 1 is a view schematically showing a configuration of a store supporting system according to a first embodiment;

FIG. 2A is a block diagram of a configuration of a server of the store supporting system;

FIG. 2B is a conceptual view of a configuration of a learning device of the store supporting system;

FIG. 3 is a view of overall operation of the store supporting system;

FIG. 4 is a view of the overall operation of the store supporting system;

FIG. 5 is a flow chart of the overall operation of the store supporting system;

FIG. 6 is an illustrative view conceptually showing a process of clustering in the store supporting system;

FIG. 7A is a schematic perspective view of a target store into which the store supporting system is introduced;

FIG. 7B is a schematic perspective view of a display rack in the target store;

FIG. 8 is a schematic front view of a display rack in the target store;

FIG. 9 is a flow chart of a process of a shelf allocation adjustment in the store supporting system;

FIG. 10A is a graph of an estimation result based on a learned model before correction in the store supporting system, where the abscissa represents the SKU number and the ordinate represents the sales amount; and

FIG. 10B is a graph of an estimation result based on a learned model after correction in the store supporting system, where the abscissa represents the SKU number and the ordinate represents the sales amount.

### DESCRIPTION OF EMBODIMENTS

### First Embodiment

(1) Overview

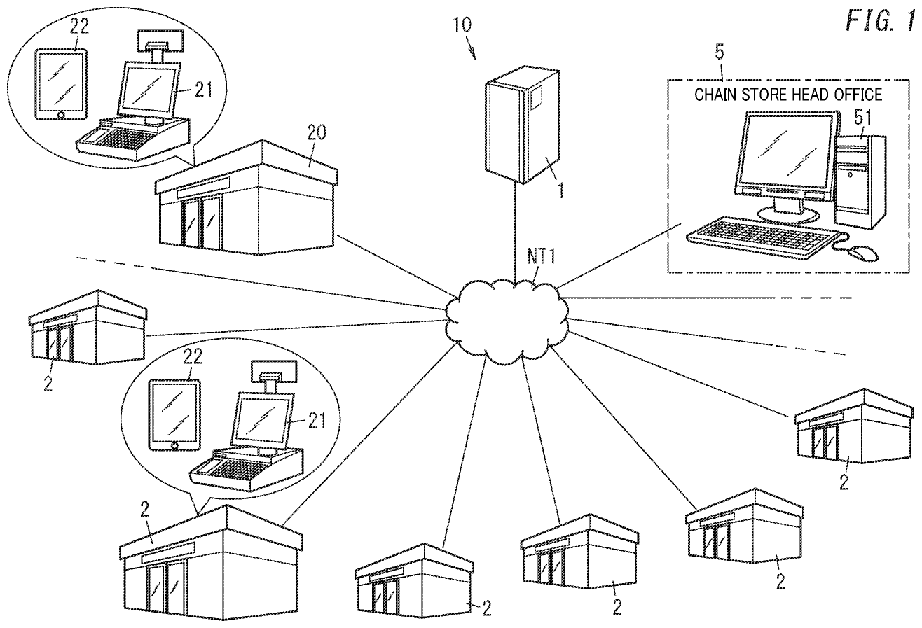

A store supporting system 10 (see FIG. 1) according to the present embodiment is a system configured to support operation of a target store 20 (see FIG. 1). The target store 20 as used herein is a store of a plurality of stores 2 (see FIG. 1) which is to be a target supported by the store supporting system 10. In the present embodiment, an example is described in which the store supporting system 10 is introduced into the stores 2 which are retail establishments such as convenience stores, supermarkets, department stores, drugstores, apparel stores, consumer electronics stores, or hardware stores.

The store supporting system 10 according to the present embodiment is a system configured to improve a management index, which will be described later, for the target store 20, thereby improving a financial condition of the target store 20. More specifically, the store supporting system 10 is a system configured to improve the sales amount, the customer unit price, the average value of Life Time Values (LTVs), the profit (including the gross profit, the operating profit, and the like), or the like of the target store 20, thereby improving the management index of the target store 20. Each of the sales amount, the customer unit price, the customer unit price, the average value of the LTVs, the profit, and the like as mentioned in the present disclosure is a value calculated for a prescribed time period (e.g., the present month, the last three months, the last one month, or the last one week).

The store supporting system 10 proposes, as a means of improving the management index of the target store 20 as described above, recommendation information for making the product configuration (product lineup) of products 3 in the target store 20 proper. The target store 20 changes, based on such recommendation information, the operation, specifically the product configuration, of the target store 20, thereby improving the management index.

The store supporting system 10 according to the present embodiment generally uses, as an approach to obtain the recommendation information described above, result data of a store 2 similar to the target store 20. That is, the store supporting system 10 generates, based on the result data of the store 2 similar to the target store 20, recommendation information for making the product configuration of the products 3 in the target store 20 proper. In this embodiment, the store 2 similar to the target store 20 is a store that satisfies a prescribed condition of similarity to the target store 20. For example, when a plurality of stores 2 are operated in an organization of a chain such as a corporate chain (regular chain) or a franchise chain, these plurality of stores 2 are deemed to satisfy the condition of similarity to each other. The condition of similarity may include conditions relating to countries, regions, hours of operation, customer segments, and the like.

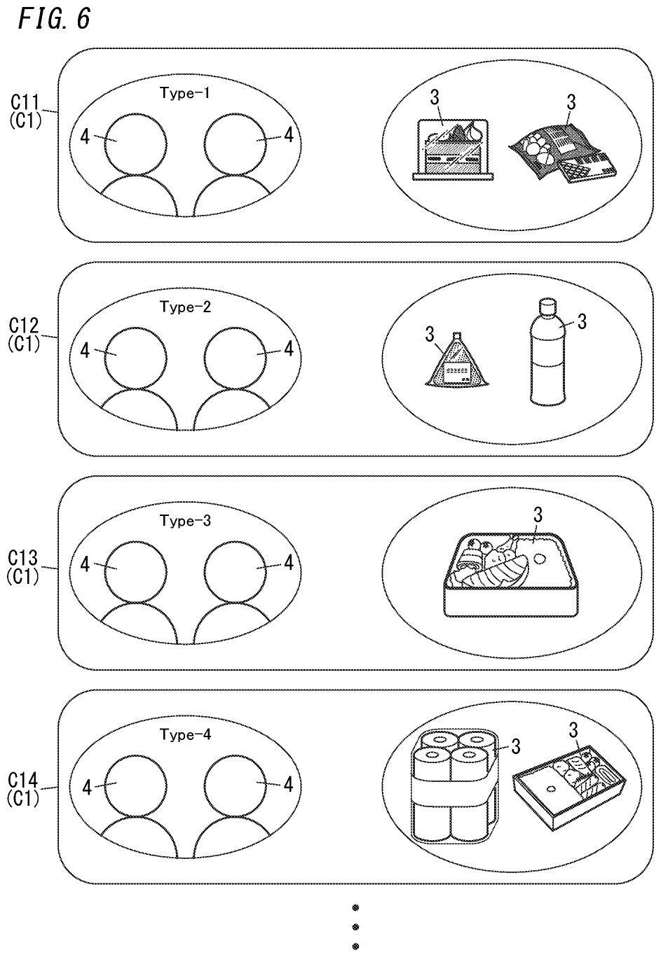

Moreover, the store supporting system 10 according to the present embodiment obtains the recommendation information described above by, in detail, an approach using a learned model which has been learned by machine learning and an approach using clustering data obtained by clustering. That is, the store supporting system 10 uses the learned model which has been learned by machine learning with the result data of the store 2 similar to the target store 20, thereby generating the recommendation information for the target store 20. Moreover, the store supporting system 10 uses clustering data obtained by clustering the result data of the store 2 similar to the target store 20 in various units of, for example, a customer 4 (see FIG. 6), a checkout process, or the store 2, thereby generating the recommendation information for the target store 20. These two approaches are applicable in combination.

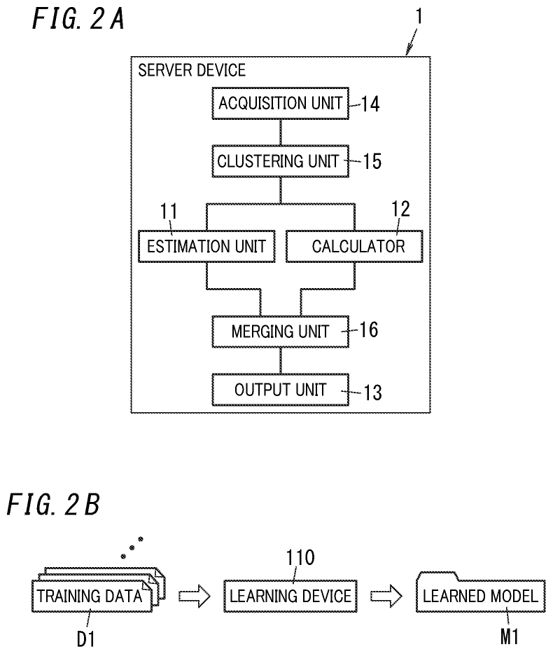

Thus, the store supporting system 10 according to the present embodiment includes an estimation unit 11 and an output unit 13 as shown in FIG. 2A. The estimation unit 11 estimates, based on a learned model M1, the management index by using at least operation information as input information. The operation information is information on operation of the target store 20 which is a specific store 2. The management index is an index relating to management of the target store 20. The learned model M1 is generated by machine learning with data, as training data D1 (see FIG. 2B), including information on operation of the store 2 and an index relating to management of the store 2. The output unit 13 obtains, based on a result of estimation by the estimation unit 11, recommendation information relating to the operation of the target store 20 and recommendable for the target store 20, and the output unit 13 outputs the recommendation information.

As used herein, the “operation information” on the operation of the target store 20 is, for example, information on the product lineup, that is, the product configuration for the target store 20. Specific examples of such operation information include Stock Keeping Unit (SKU) number and the number of items for each of product categories. Moreover, the “management index” relating to the management of the target store 20 is, for example, information on the sales amount of the target store 20. Specific examples of such a management index include the sales amount for each product category, the customer unit price, the average value of the LTVs, the profit (including the gross profit, the operating profit, and the like), and the number of customers of the target store 20. The estimation unit 11 inputs such operation information to the learned model M1 to estimate, based on the learned model M1, such a management index, thereby finding the relationship of the product configuration to the sales amount and the like in the target store 20.

The output unit 13 obtains, based on an estimation result of the relationship of the product configuration (e.g., the SKU number) to the sales amount and the like in the target store 20, recommendable information, for example, on the product configuration of the target store 20 as “recommendation information”. That is, the “recommendation information” is, in a similar manner to the “operation information”, information relating to the operation of the target store 20 and is, for example, information on the product lineup, that is, the product configuration for the target store 20. Specific examples of such recommendation information include the SKU number and the number of items for each product category.

The store supporting system 10 described above provides, as recommendable information on the operation of the target store 20, recommendation information which, for example, leads to an improvement in the management index of the target store 20 and consequently to an improvement in the financial condition of the target store 20. In this embodiment, the management index to be used to obtain the recommendation information is estimated based on the learned model M1 by using at least operation information as input information. The learned model M1 is generated by machine learning with data, as the training data D1, including the information on the operation of the store 2 and the index relating to the management of the store 2. In other words, the learned model M1 to be used to estimate the management index is generated from the training data D1 including the information on the operation and the index relating to the management of one or more stores 2, and the estimation of the management index is thus based on the result data of the store(s) 2. Consequently, the store supporting system 10 provides the advantage that the operation of the target store 20 is easily properly supported.

Incidentally, the store supporting system 10 is particularly useful, for example, when the number of stores 2, such as convenience stores, which can be references of the target store 20 may be large, for example, is greater than or equal to 100, greater than or equal to 1000, or greater than or equal to 10000.

That is, a large number of stores 2 usually do their business under individually different conditions, and thus, reflection of a large quantity of information on these a large number of stores 2 to the target store 20 requires computation and the like far beyond human processing ability and can no way be achieved by humans. In addition, the information on the operation and the management of the large number of stores 2 changes over time (e.g., seasonally) as needed, and therefore, the recommendation information can no way be updated by humans in consideration of the newest information on the large number of stores 2. Moreover, the process of processing such a huge quantity of changing information is difficult for general information processing devices to say nothing of humans.

In contrast, the store supporting system 10 according to the present embodiment uses, for machine learning of the learned model M1 to be used in the estimation process, the information on the operation and the management of the large number of stores 2 and can thus process the huge quantity of changing information as described above. Rather, in the machine learning, an increased data amount of the training data D1 is expected to improve the accuracy of the learned model M1 to be generated, and therefore, the information on the large number of stores 2 is favorably used as the training data D1. Thus, the store supporting system 10 according to the present embodiment is particularly useful in a business category in which a large number of stores 2 can be operated.

As shown in FIG. 2A, the store supporting system 10 according to the present embodiment further includes a calculator 12 and the output unit 13. The calculator 12 obtains, based on a plurality of clusters C1 (see FIG. 6), trend information on a purchase trend of the products 3 in the target store 20 which is the specific store 2. The plurality of clusters C1 are obtained by classifying a data group including purchase histories of products 3 in the plurality of stores 2 in accordance with a rule about the purchase trend of the products 3 into the plurality of clusters C1. The output unit 13 obtains, based on the trend information, the recommendation information relating to the operation of the target store 20 and recommendable for the target store 20, and the output unit 13 outputs the recommendation information.

As used herein, the “trend information” is information on the purchase trend of the products 3 in the target store 20 and is obtained based on the plurality of clusters C1 by the calculator 12. Specific examples of the trend information include the component ratio of the plurality of clusters C1 of the target store 20. Moreover, the “purchase trend” as used herein is a trend observed in connection with buying the products 3. Specific examples of the purchase trend includes a product 3 frequently purchased for each product category or a combination of frequently purchased products 3.

Moreover, the plurality of clusters C1 are pieces of information obtained by classifying, for example, a data group including purchase histories of a plurality of customers 4 in the plurality of stores 2 in accordance with type of the customers 4 whose purchase trends differ. Specific examples of such a plurality of clusters C1 include a “customer who purchases sweet food and salty, crunchy snacks together” and a “customer who purchases a rice ball and green tea together”. The calculator 12 obtains, based on such a plurality of clusters C1, the trend information on the target store 20, thereby finding the purchase trend in the target store 20 from purchase trends in the plurality of stores 2 in consideration of the relationship of the target store 20 to the plurality of clusters C1.

The output unit 13 obtains, based on the trend information representing the purchase trend in the target store 20, for example, recommendable information on the product configuration of the target store 20 as the “recommendation information”. That is, the “recommendation information” is information relating to the operation of the target store 20 and is, for example, information on the product lineup, that is, the product configuration for the target store 20. Specific examples of such recommendation information include recommended product information on one or more recommended products for each product category.

The store supporting system 10 described above provides, as recommendable information on the operation of the target store 20, recommendation information which, for example, leads to an improvement in the management index of the target store 20 and consequently to an improvement in the financial condition of the target store 20. Here, the trend information used to obtain the recommendation information is obtained based on the plurality of clusters C1. The plurality of clusters C1 are obtained by classifying a data group including purchase histories of products 3 in the plurality of stores 2 in accordance with a rule about the purchase trend of the products 3 into the plurality of clusters C1. In other words, the plurality of clusters C1 to be used to obtain the trend information are obtained by classifying, based on the rule about the purchase trend, purchase histories for the stores 2 except for the target store 20, and the trend information is thus based on the result data of the store(s) 2. Consequently, the store supporting system 10 provides the advantage that the operation of the target store is easily properly supported.

(2) Details

The store supporting system 10 according to the present embodiment will be explained in detail below. In the present embodiment, a convenience store is described as an example of the store 2 in which the store supporting system 10 is introduced. That is, a “sales clerk” is a sales clerk (including part-timers) in a convenience store and the “customer 4” is a customer of the convenience store.

In such a store 2, the sale of a plurality of products 3 is conducted with the plurality of products 3 being displayed in the store 2. The customer 4 picks up one or more desired products 3 from the plurality of products 3 displayed in the store and performs a checkout process of the one or more desired products 3 thus picked up, thereby purchasing the one or more desired products 3.

(2.1) Premises

The “training data” as used in the present disclosure is data including pieces of data (input data) corresponding to questions and pieces of data (correct answer data) corresponding to answers. In individual training data D1, the pieces of input data are associated with the pieces of correct answer data on a one-to-one basis. In other words, of the pieces of data to be used for the machine learning, data with a correct answer (with a label) is referred to as the training data (Labeled Data) D1. Supervised learning with such training data D1 generates a learned model for estimating correct answer data by extracting a feature amount from the input data.

As used in the present disclosure, “Stock Keeping Unit (SKU)” means a minimum management unit in order receiving and placing management or stock management of products 3. For example, products having the same product name but differing in size, color, package, quantity per package, or the like are counted as different SKUs and are classified, as the SKUs, into smaller units than an item.

As used in the present disclosure, the “item” means one product in a broad sense, and, for example, products having the same product name are counted as one item. For example, when products named “ABC bread” have three types, namely, bread cut into four slices, five slices, and six slices, the number of items is “1” and the SKU number is “3” for the “ABC bread”.

As used in the present disclosure, “Life Time Value (LTV)” means a consideration for service, the consideration being paid for a prescribed time period (Life Time) by a customer 4 provided with the service. For example, in the case of the prescribed time period being one day (24 hours), the amount of money used in the target store by a customer 4 in one day is the LTV of the customer 4. Therefore, in the case, for example, where a customer 4 makes purchases N times (N is greater than or equal to 2) in the target store in one day, the total amount of money used by the customer 4 for the N times of the purchases, but not the amount of money used by the customer 4 for one purchase, is the LTV of the customer 4. Thus, the LTV is superficially similar to the customer unit price but is different from the customer unit price in that the LTV represents the total amount of money used during a prescribed time period.

As used in the present disclosure, the “profit” means profit in general relating to the sales amount in the target store 20 and includes, for example, gross profit (gross margin), operating profit, management profit, income before income tax, and income after income tax.

As used in the present disclosure, the “product category” is a label for classifying product 3 on the basis of applications, functions, customer segments, or the like and may be relatively rough classification (large category) such as food, clothing, medication, aesthetic-related products, electronics appliance, or daily commodities. Moreover, the product category may be a medium category which further classifies the large category into a plurality of categories, and specific examples of the medium category of the food include soft drink, alcohol, boxed lunch, delicatessen, sweet food, snacks, and ice cream. Moreover, the product category may be a small category which further classifies the medium category into a plurality of categories, and specific examples of the small category of the soft drink include barley tea, green tea, black tea, coffee, lactic fermenting beverage, carbonated drink, mineral water, and sports drink.

Incidentally, in the present embodiment, the number of stores 2 which can serve as references for the target store 20 is assumed to be, for example, greater than or equal to 10000. In the following description, one of the plurality of (a large number of) stores 2 is the target store 20, but practically, each of the plurality of stores 2 can be the target store 20. That is, each of the plurality of stores 2 can be a target supported by the store supporting system 10, but to simplify the description, the number of target stores 20 is hereinafter assumed to be one.

(2.2) Configuration

First of all, the configuration of the store supporting system 10 according to the present embodiment will be described with reference to FIGS. 1, 2A, and 2B.

As shown in FIG. 1, the store supporting system 10 includes a server device 1. In the present embodiment, the store supporting system 10 further includes Point Of Sales (POS) systems 21 and store terminals 22, and the POS system(s) 21 and the store terminal(s) 22 are installed in each of the plurality of stores 2 (including the target store 20). Moreover, in the present embodiment, the store supporting system 10 further includes a head office terminal 51 installed in a chain store head office 5 of the plurality of stores 2.

That is, in the present embodiment, in addition to the server device 1, the POS systems 21, the store terminals 22, and the head office terminal 51 are included in components of the store supporting system 10. However, at least any of the POS system 21, the store terminals 22, or the head office terminal 51 does not have to be included in the components of the store supporting system 10.

The server device 1, the POS systems 21, the store terminals 22, and the head office terminal 51 included in the store supporting system 10 are connected to a network NT1 such as the Internet. Here, the server device 1 is configured to communicate with each of the POS systems 21, the store terminals 22, and the head office terminal 51. As used herein, “be configured to communicate” means that a signal can be directly, or indirectly via the network NT1, a relay, or the like, transmitted and received based on an appropriate scheme of communication which is wired communication or wireless communication. In the present embodiment, the server device 1 is configured to bidirectionally communicate with each of the POS systems 21, the store terminals 22, and the head office terminal 51. Moreover, in the present embodiment, the POS systems 21, the store terminals 22, and the head office terminal 51 are configured to communicate with one another.

The server device 1 includes, as a main component, a computer system including one or more processors and a memory. The server device 1 is connected to the network NT1. The server device 1 is installed in, for example, a service company which provides the store supporting system 10 or a company which operates the stores 2. The server device 1 uses a Platform as a Service (PaaS) environment and preferably uses a public cloud environment involving no management of an OS, a run-time, and middleware.

As shown in FIG. 2A, the server device 1 includes the estimation unit 11, the calculator 12, and the output unit 13. Moreover, in the present embodiment, the server device 1 further includes an acquisition unit 14, a clustering unit 15, and a merging unit 16 in addition to the estimation unit 11, the calculator 12, and the output unit 13. In the server device 1, the one or more processors execute programs stored in the memory to implement functions as at least the estimation unit 11, the calculator 12, the output unit 13, the acquisition unit 14, the clustering unit 15, and the merging unit 16. The program may be stored in advance in the memory.

Alternatively, the program may also be downloaded via a telecommunications network such as the Internet or may be distributed after having been stored in a non-transitory storage medium such as a memory card.

The estimation unit 11 estimates, based on the learned model M1, the management index by using at least the operation information as input information. The operation information is information on the operation of the target store 20 which is the specific store 2. The management index is the index relating to the management of the target store 20. The learned model M1 is generated by machine learning with data, as the training data D1, including the information on the operation of the store 2 and the index relating to the management of the store 2.

Moreover, in order to estimate the management index, the estimation unit 11 at least uses at least the operation information as input information to the learned model M1 or may use information other than the operation information as the input information to the learned model M1. Examples of the information which is other than the operation information and which the estimation unit 11 uses as the input information to the learned model M1 may include auxiliary information for improving the accuracy of estimation by the estimation unit 11 and a restriction condition that defines a restriction on the operation information.

Thus, in the present embodiment, the estimation unit 11 further uses, as input information, the auxiliary information for improving the accuracy of estimation in addition to the operation information. As used in the present disclosure, the “auxiliary information” is information which is different from the operation information and which is for improving the accuracy of estimation by the estimation unit 11. The “auxiliary information” includes, for example, information on the purchase trend in the target store 20. Moreover, the “auxiliary information” may include, as information other than the information on the purchase trend, information on an environment surrounding the target store 20, and the location, layout, and the like of the target store 20. The auxiliary information further includes occasionally changing dynamic information, such as whether or not any event (e.g., sporting, concert) takes place, a weather condition (including weather), a traffic condition (e.g., road closure), and the like around the target store 20. Specific examples of the environment surrounding the target store 20 include the total population, the population by age group, the population ratio of daytime and nighttime, the number of offices, the number of workers, the number of stations, and the number of users of the stations within a certain area (trading zone) from the target store 20. The specific examples of the environment surrounding the target store 20 further include the number and types of competing stores of the target store 20, the number and types of facilities, such as stadiums and concert halls, having customer attracting effects within the certain area (trading zone) from the target store 20. Specific examples of the location and layout of the target store 20 include whether or not parking lots are provided, whether or not bicycle parking lots are provided, the number of parking lots, the site area, whether or not a dining area is provided, whether or not an advertising display is provided, and whether or not the target store 20 faces a main street.

Moreover, in the present embodiment, the estimation unit 11 further uses, as input information, the restriction condition that defines the restriction on the operation information in addition to the operation information (and the auxiliary information). As used in the present disclosure, the “restriction condition” is information which is different from the operation information and which is for setting any restriction on the operation information. Examples of the “restriction condition” include a condition relating to the size of each of a plurality of products 3 included in the same product category. Moreover, the “restriction condition” includes a condition that defines at least one of a maximum value or a minimum value of the SKU number or the number of items in one product category.

As shown in FIG. 2B, the store supporting system 10 according to the present embodiment includes a learning device 110 for generating the learned model M1. The learning device 110 generates the learned model M1 to be used in the store supporting system 10. The store supporting system 10 as mentioned herein has a function of estimating the management index by using, as input information, the operation information as described above. The management index relates to the management of the target store 20 which is at least a specific store. The operation information is information on the operation of the target store 20. The learning device 110 generates the learned model M1 by machine learning with data which is input as the training data D1 to the learning device 110 and which includes the information on the operation of the store 2 and the index relating to the management of the store 2.

In the present embodiment, the server device 1 includes the learning device 110 as one function of the server device 1. In particular, in the present embodiment, the learning device 110 (learning machine) which has machine learned functions as the estimation unit 11. That is, the estimation unit 11 of the server device 1 functions as the learning device 110 in the “learning phase” in which the machine learning is performed and functions as the estimation unit 11 in the “inference phase” in which estimation is performed based on the learned model M1.

The calculator 12 obtains, based on the plurality of clusters C1 (see FIG. 6), trend information on a purchase trend of the products 3 in the target store 20 which is the specific store 2. The plurality of clusters C1 are obtained by classifying a data group including purchase histories of products 3 in the plurality of stores 2 in accordance with a rule about the purchase trend of the products 3 into the plurality of clusters C1.

The output unit 13 obtains, based on a result of estimation by the estimation unit 11, recommendation information relating to the operation of the target store 20 and recommendable for the target store 20, and the output unit 13 outputs the recommendation information. Moreover, the output unit 13 obtains, based on the trend information, the recommendation information and outputs the recommendation information. That is, in the present embodiment, the output unit 13 obtains the recommendation information in accordance with both the result of estimation by the estimation unit 11 and the trend information calculated by the calculator 12.

An aspect of outputting various kinds of information from the output unit 13 is, for example, outputting (transmitting) by communication with the POS system 21, the store terminal 22, the head office terminal 51, and the like. The aspect is, however, not limited to these examples. The output unit 13 may output the various kinds of information, such as the recommendation information, by transmission to another information terminal, displaying, outputting sound (including voice), recording (writing) in a non-transitory recording medium, printing-out, or the like.

The acquisition unit 14 acquires various types of information via the network NT1 from the POS system 21, the store terminal 22, the head office terminal 51, and the like. At least, the acquisition unit 14 acquires pieces of data including purchase histories of products 3 from the POS systems 21 of the plurality of stores 2 to generate a data group including the purchase histories of the products 3.

The clustering unit 15 executes a clustering process of generating the plurality of clusters C1. That is, the clustering unit 15 classifies, based on a rule about the purchase trend of the products 3, the data group including the purchase histories, acquired by the acquisition unit 14, of the products 3 in the plurality of stores 2 into the plurality of clusters C1. In the present embodiment, the plurality of clusters C1 are pieces of data obtained by classifying the data group in units of the customer 4, which will be described later in detail.

The merging unit 16 merges the result of estimation by the estimation unit 11 and the trend information obtained by the calculator 12 to obtain a merged result and outputs the merged result to the output unit 13. Thus, the output unit 13 obtains the recommendation information in accordance with both the result of estimation by the estimation unit 11 and the trend information. In the present embodiment, the merging unit 16 merges the trend information calculated by the calculator 12 by the operation information (SKU number for each product category) included in the result of estimation by the estimation unit 11, thereby merging the result of estimation by the estimation unit 11 and the trend information, which will be described later in detail.

Incidentally, the learned model M1 used by the estimation unit 11 in the present embodiment is generated by the machine learning by the learning device 110 as described above. The learning device 110 and the estimation unit 11 may be embodied as any type of artificial intelligence or system. Moreover, the clustering unit 15 may also be implemented as any type of artificial intelligence or system. In the present embodiment, for example, the estimation unit 11 performs machine learning that deals with a regression problem, and the estimation unit 11 performs supervised learning as a method of the machine learning. In contrast, the clustering unit 15 performs machine learning that deals with a classification problem, and the clustering unit 15 performs unsupervised learning as a method of the machine learning.

In this case, an algorithm of the machine learning which the estimation unit 11 dealing with the regression problem applies is, for example, the multiple regression analysis. However, the algorithm of the machine learning applied by the estimation unit 11 is not limited to the multiple regression analysis but may be, for example, Neural Network, Random Forest, decision tree, or eXtreme Gradient Boosting (XGB) regression, Support Vector Regression (SVR), or the like.

On the other hand, the algorithm of the machine learning applied by the clustering unit 15 which deals with the classification problem is, for example, Gaussian Mixture Model (GMM), k-means clustering, or the like. Note that the algorithm of the machine learning applied by the clustering unit 15 is not limited to these algorithms but may be, for example, Mean-shift, a Ward method, Latent Dirichlet Allocation (LDA), Density-based spatial clustering of applications with noise (DBSCAN), or the like.

Moreover, in the present embodiment, as described above, the learning method adopted by the estimation unit 11 which deals with the regression problem is the supervised learning, and the learning method adopted by the clustering unit 15 which deals with the classification problem is the unsupervised learning. Thus, as the training data D1 for generation of the learned model M1 to be used by the estimation unit 11, data (Labeled Data) with a correct answer (with a label) is used as described above. Labeling may be performed by human. However, the learning method adopted by the estimation unit 11 is not limited to the supervised learning but may be unsupervised learning or reinforcement learning.

In each store 2 (inclusively of the target store 20), one or more POS systems 21 and one or more store terminals 22 are installed as described above. A plurality of POS systems 21 and a plurality of store terminals 22 may be provided in one store 2. In FIG. 1, each store 2 is shown as if it is connected to the network NT1. However, in practice, apparatuses such as the POS system 21 and the store terminal 22 installed in each store 2 are connected to the network NT1 via a gateway or the like.

Each of the POS system 21 and the store terminal 22 includes, as a main component, a computer system including one or more processors and a memory. Thus, the one or more processors execute programs stored in the memory to implement functions as the POS system 21 and the store terminal 22. The program may be stored in advance in the memory. Alternatively, the program may also be downloaded via a telecommunications network such as the Internet or may be distributed after having been stored in a non-transitory storage medium such as a memory card.

In the present embodiment, in particular, the POS system 21 is a so-called “ID-POS” configured to handle ID-POS data. As used herein, the “ID-POS data” is data obtained by adding, to the POS data, a “customer ID” as the identification (ID) information of the customer 4. Such a POS system 21 (ID-POS) authenticates the customer 4 when the customer 4 makes a purchase, thereby acquiring the identification information (customer ID) of the customer 4. Authentication of the customer 4 may be performed by, for example: various kinds of cards such as member's cards, royalty cards, and credit cards; communication with a portable information terminal of the customer 4; or biometrics authentication (including facial recognition).

The store terminal 22 is an information terminal owned by a sales clerk or an owner of the store 2. The store terminal 22 has a touch screen as a user interface and receives an operation given by a user and presents (displays) information to the user.

The POS system 21 and the store terminal 22 as described above are configured to transmit the purchase histories of the products 3 in at least the store 2 as data via the network NT1 to the server device 1. In particular, in the present embodiment, the POS system 21 is configured to handle the ID-POS data, and therefore, for example, each time a checkout process is performed, the POS system 21 can output, as a purchase history, information on one or more products 3 thus purchased with the information being associated with the identification information (customer ID) of the customer 4.

Moreover, each store 2 may have an apparatus to be connected to the network NT1 in addition to the POS system 21 and the store terminal 22. For example, an apparatus including, as a main configuration, a computer system, such as a store computer, a portable terminal (including, for example, a smartphone and a wearable terminal) carried by each sales clerk 91, or the like may be provided in each store 2 and may be connected to the network NT1.

The head office terminal 51 is installed in the chain store head office 5 of the plurality of stores 2 as described above. The head office terminal 51 includes, as a main component, a computer system including one or more processors and a memory. Thus, the one or more processors executes a program stored in the memory to implement a function as the head office terminal 51. The program may be stored in advance in the memory. Alternatively, the program may also be downloaded via a telecommunications network such as the Internet or may be distributed after having been stored in a non-transitory storage medium such as a memory card.

The head office terminal 51 has a touch screen as a user interface and receives an operation given by a user and presents (displays) information to the user. A user of the head office terminal 51 is mainly an operator of the chain store head office 5.

(3) Operation

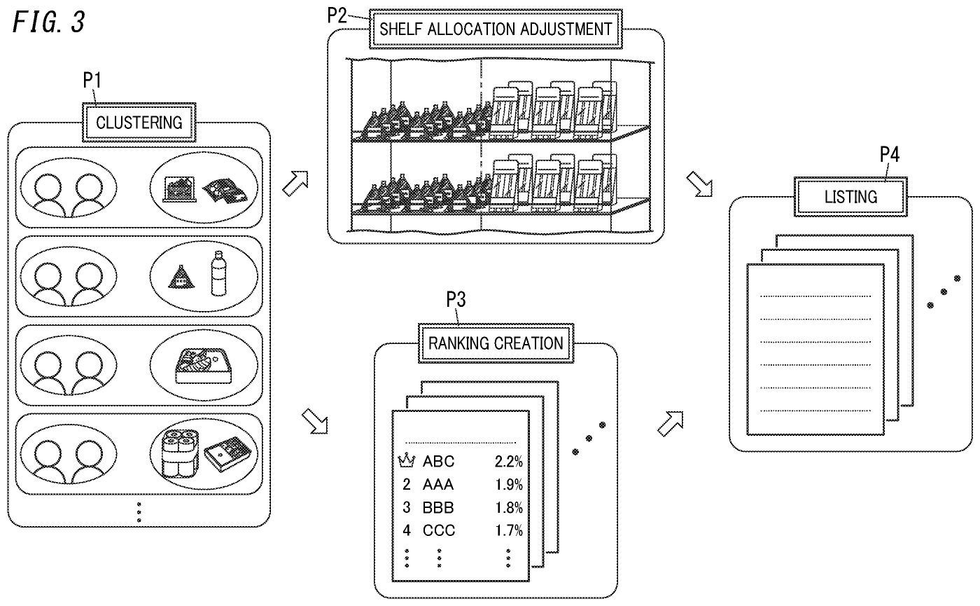

Operation of the store supporting system 10 according to the present embodiment, that is, a store supporting method according to the present embodiment will be described in detail below with reference to FIGS. 3 to 11.

First of all, overall operation of the store supporting system 10, that is, the whole of the store supporting method will be described, and then, the operation of the store supporting system 10 will be described by stage below. Thereafter, operation of the learning device 110 (learning machine) for generating the “learned model” to be used by the estimation unit 11 of the store supporting system 10, that is, a generation method of the learned model M1 according to the present embodiment will be described.

(3.1) Overall Operation

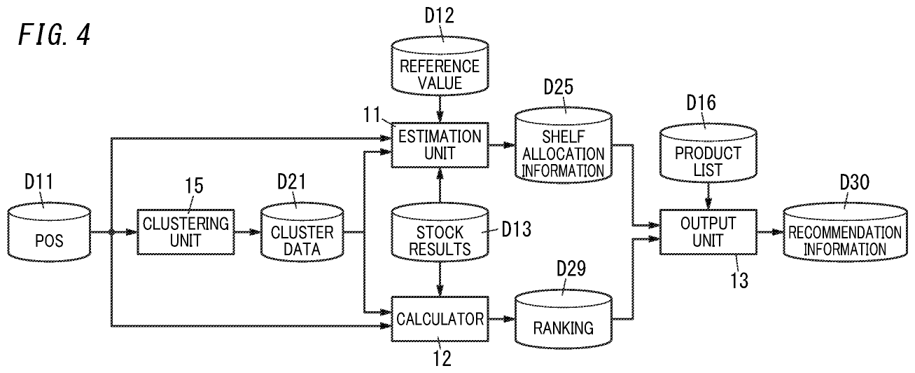

FIGS. 3 and 4 are conceptual views conceptually illustrating the overall operation of the store supporting system 10 according to the present embodiment.

As shown in FIG. 3, the operation of the store supporting system 10 includes, when broadly explained, four processes, namely, clustering P1, a shelf allocation adjustment P2, ranking creation P3, and listing P4.

The clustering P1 is a process of classifying a data group including purchase histories of the products 3 in the plurality of stores 2 in accordance with a rule about the purchase trend of the products 3 into the plurality of clusters C1. The clustering P1 is mainly executed by the clustering unit 15.

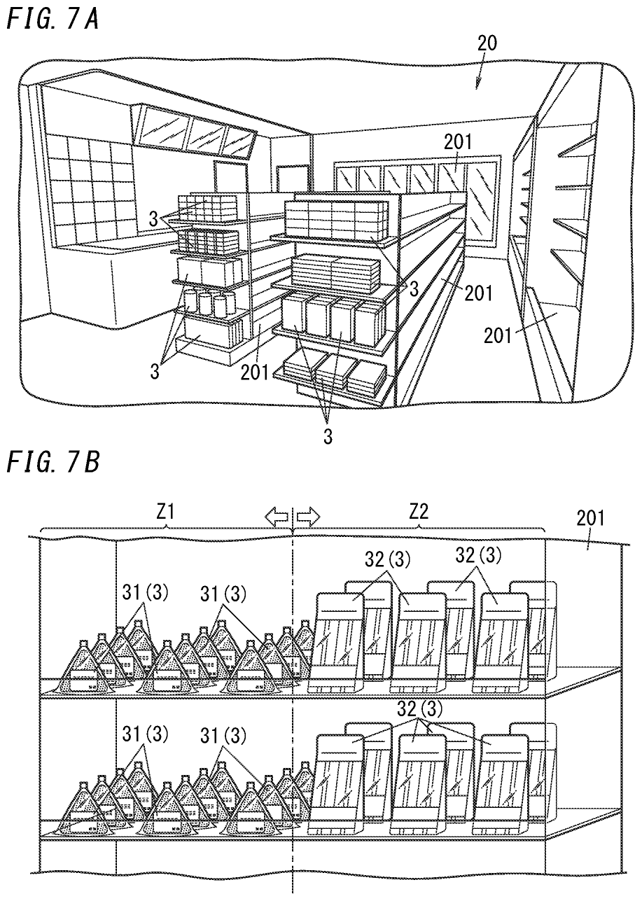

The shelf allocation adjustment P2 is a process for making proper the shelf allocation in the target store 20. As used in the present disclosure, the “shelf allocation” means design such as the number of products 3 to be displayed on a display rack 201 (see FIG. 7A). Thus, the process of the shelf allocation adjustment P2 includes a process of obtaining recommendable information on the product configuration of the target store 20. The shelf allocation adjustment P2 is mainly executed by the estimation unit 11 and the output unit 13.

The ranking creation P3 is a process for creating a ranking of recommended products in the target store 20. In the present embodiment, the ranking of the recommended products is created for each product category on the basis of the plurality of clusters C1. Thus, the process of the ranking creation P3 includes a process of obtaining, on the basis of the plurality of clusters C1, the trend information on the purchase trend of the products 3 in the target store 20. The ranking creation P3 is mainly executed by the calculator 12 and the output unit 13.

The listing P4 is a process for creating a list of the recommended products as recommendation information D30 (see FIG. 4). In the present embodiment, the recommendation information D30 is generated based on shelf allocation information D25 (see FIG. 4) obtained by the shelf allocation adjustment P2 and a ranking D29 (see FIG. 4) obtained by the ranking creation P3. The listing P4 is mainly executed by the output unit 13.

FIG. 4 is a conceptual view briefly illustrating a flow of data when the store supporting system 10 (server device 1) according to the present embodiment executes the four processes, namely, the clustering P1, the shelf allocation adjustment P2, the ranking creation P3, and the listing P4. That is, FIG. 4 shows the overall operation of the server device 1 including the estimation unit 11, the calculator 12, and the output unit 13, that is, the whole of the store supporting method.

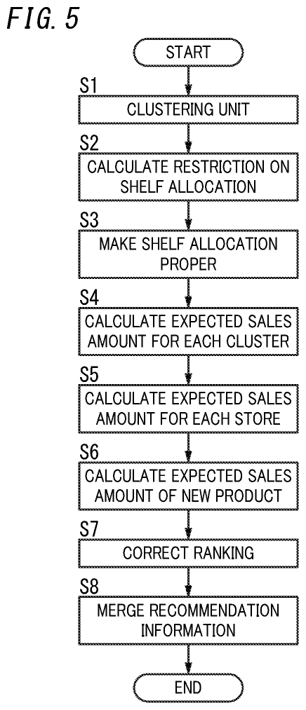

Moreover, FIG. 5 is a flow chart corresponding to the overall operation of the store supporting system 10, that is, the whole of the store supporting method. That is, FIG. 5 conceptually illustrates the flow of main processes of the store supporting system 10.

(3.2) Clustering

Next, with reference to FIGS. 4 to 6, the process of the clustering P1 will be described in further detail. In the clustering P1, the potential of the target store 20 based on the results of the plurality of stores 2 can be grasped based on, for example, the component ratio of the plurality of clusters C1 for the target store 20. Then, a result obtained by the clustering P1 is to be used for the shelf allocation adjustment P2 and the ranking creation P3.

In the present embodiment, the plurality of clusters C1 generated by the clustering P1 are pieces of data obtained by classifying a data group in units of the customer 4 as described above. Thus, the process of the clustering P1 in the present embodiment includes a step of clustering (S1 in FIG. 5) in which clustering is performed in units of the customer 4.

FIG. 6 is a conceptual view conceptually showing a plurality of clusters C11, C12, C13 . . . obtained by the clustering. When the plurality of clusters C11, C12, C13 . . . are not particularly distinguished from one another, each of the plurality of clusters C11, C12, C13 . . . is simply referred to as a “cluster C1”. That is, the plurality of clusters C1 are pieces of data obtained by classifying, based on a rule about the purchase trend of the products 3, a data group in units of the customer 4. Thus, customers 4 are to be classified into the plurality of clusters C1 represented by, for example, “Type-1”, “Type-2”, “Type-3” . . . depending on the purchase trends of the products 3.

In the example shown in FIG. 6, the cluster C11 is a cluster of customers 4 of “Type-1” satisfying the rule about the purchase trend “customer who purchases sweet food and salty, crunchy snacks together”. The cluster C12 is a cluster of customers 4 of “Type-2” satisfying the rule about the purchase trend “customer who purchases a rice ball and green tea together”. The cluster C13 is a cluster of customers 4 of “Type-3” satisfying the rule about the purchase trend “customer who purchases a boxed lunch as a single product item”. The cluster C14 is a cluster of customers 4 of “Type-4” satisfying the rule about the purchase trend “customer who purchases a boxed lunch and a daily commodity together”.

That is, the clustering generates a plurality of clusters C1 by classifying, in accordance with the type of the customers 4 differing in the purchase trend, the data group including purchase histories of the plurality of customers 4 in the plurality of stores 2 as described above.

Specifically, the server device 1 acquires POS data D11 from the plurality of stores 2 by the acquisition unit 14. The POS data D11 used herein includes a combination of the identification information (customer ID) of the customers 4 and information (including the unit price and the number of purchased products) on one or more products 3 purchased and the date of purchase, and the POS data D11 further includes “store ID” as identification information for identifying each store 2.

From the POS data D11 read in this way, a data group of purchase histories is generated, and for this data group, a purchase amount ratio, for each customer 4, by product category is calculated.

Next, for the purchase amount ratio thus calculated, the clustering is executed to generate the plurality of clusters C1. Thus, in a classification aspect which is the product category, the customers 4 are classified by the type relating to the purchase trend, thereby generating the plurality of clusters C1 classified in units of the customer 4. At this time, an output result of the clustering is data representing with which of the plurality of clusters C1 each customer 4 is affiliated. In particular, in the present embodiment, a soft (fuzzy) cluster C1 is assumed, where one customer 4 is affiliated with a plurality of clusters C1. Therefore, for example, when a customer 4 includes 80% of “Type-1” elements and 20% of “Type-2” elements, the customer 4 is affiliated with the cluster C11 by 80% and the cluster C12 by 20%. Thus, for each customer 4, cluster data D21 representing the affiliation proportions of the plurality of clusters C1 is generated.

Moreover, for each store 2, the cluster affiliation proportions of the customers 4 are added up to obtain a cluster affiliation proportion relating to the store 2. In the present embodiment, the cluster affiliation proportion obtained by adding up the cluster affiliation proportions are normalized, thereby obtaining a cluster component ratio normalized for each store 2. That is, for a plurality of customers 4 who use each store 2, a “component ratio” is obtained which represents the proportion of the customers 4 affiliated with the plurality of clusters C1. For example, for a store 2, a component ratio is calculated such that of a plurality of customers 4 who use the store 2, 5% are affiliated with the cluster C11, 7% are affiliated with the cluster C12, and 11% are affiliated with the cluster C13.

The clustering unit 15 incorporates the cluster component ratio, thus calculated, for each store 2 into the cluster data D21 and outputs the cluster data D21. Consequently, for each of the plurality of stores 2, the cluster component ratio is obtained. Note that in the present embodiment, the component ratio of the plurality of clusters C1 for at least the target store 20 is at least obtained. Thus, calculating the component ratio of the plurality of clusters C1 for stores 2 other than the target store 20 is not essential. Consequently, trend information including the component ratio of the plurality of clusters C1 in the target store 20 is obtained based on the plurality of clusters C1. In other words, the trend information includes the component ratio of the plurality of clusters C1 in the target store 20.

Incidentally, in the present embodiment, to generate the plurality of clusters C1 classified in units of the customer 4, clustering is carried out, based on, for example, the classification aspect which is the product category. However, the classification aspect is not limited to this example, and the classification aspect may include the attribute of the customer 4 in addition to or alternatively to the product category. Examples of the attribute of the customer 4 include age, gender, job category, address, and family configuration. Additionally, or alternatively to the product category and the attribute of the customer 4, a purchase scene, a store visit frequency, a purchase price range, the number of products purchased per checkout process, preference in products 3, and the like may be included in the classification aspect. As used herein, the “purchase scene” includes a time zone and a distinction between weekdays and holidays and is represented by, for example, “weekdays 10:00 to 13:00” or “holidays 18:00 to 21:00”. When the classification aspect includes the attribute, the shop visit frequency, the purchase price range, and the like of the customer 4, it is possible to generate a cluster C1 more specifically specifying the purchase trend, for example, “male customer who is in his 30s, lives within 500 m from the store, and purchases a beer and a boxed meal at a frequency of 5 times per week in the night-time”.

Moreover, the coefficients of weight of the purchase histories are made uniform for the plurality of stores 2 in the present embodiment, but the coefficients of weight of the purchase histories may be different for each store 2. For example, weighting may be performed such that the weighting coefficient of the purchase history is larger for the target store 20 than for the other stores 2.

In this embodiment, the plurality of clusters C1 are preferably reclassified based on a result of improvement in an index relating to the management of the target store 20, the result being calculated for each cluster C1. That is, the plurality of clusters C1 generated by clustering are not fixedly defined but is changed by the reclassification. For example, it is assumed that an index (here, a sales amount of the present month) relating to the management of the target store 20 has been improved by greater than or equal to a prescribed value for the cluster C11 but has not been improved by greater than or equal to the prescribed value for the cluster C12. In this case, the cluster C11, for which the index relating to the management of the target store 20 has been improved, is preferably considered more important than the cluster C12, and the reclassification is preferably performed such that the cluster C11 is further subdivided. On the other hand, the clusters C12, for each of which the index relating to the management of the target store 20 has not been improved, are, for example, preferably aggregated to maintain the number of clusters for the clustering.

As a specific example, it is assumed that the sales amount of the cluster C1 which is a “customer who purchases snacks and soft drink together” has been improved. In this case, the cluster C1 which is the “customer who purchases snacks and soft drink together” whose sales amount has been improved is reclassified. For example, the cluster C1 which is the “customer who purchases snacks and soft drink together” is subdivided into two clusters C1, namely, a “customer who purchases salty, crunchy snacks and soft drink together” and a “customer who purchases confectionery and soft drink together”.

As an another example, it is assumed that the sales amount is not improved both for a cluster C1 which is a “customer who purchases a toiletry product and underwear together” and a cluster C1 which is a “customer who purchases stationery and a hygiene product”. In this case, the two clusters C1, namely, the “customer who purchases a toiletry product and underwear together” and the “customer who purchases stationery and a hygiene product”, for both of which the sales amount has not been improved, is reclassified. For example, the two clusters C1, namely, the “customer who purchases a toiletry product and underwear together” and the “customer who purchases stationery and a hygiene product” are aggregated in one cluster C1 which is a “customer who purchases daily commodities”.

As described above, the plurality of clusters C1 are reclassified in accordance with the degree of improvement in the financial condition of the target store 20, and thereby, a plurality of clusters C1 having high contribution ratio to an improvement in the financial condition of the target store 20 are easily obtained. The process of such reclassification may be, for example, regularly executed or executed when an improvement by greater than or equal to a prescribed value is observed for any of the clusters C1.

(3.3) Shelf Allocation Adjustment

The process of the shelf allocation adjustment P2 will now be described in more detail with reference to FIGS. 4, 5, and 7A to 10B.

The shelf allocation adjustment P2 makes proper the layout of the shelf allocation for the display rack 201 installed in the target store 20 as shown in FIG. 7A. Examples of the layout include, for example, which and how many (SKU number of) products 3 are to be displayed. For example, it is assumed that the display rack 201 is sectioned into two zones Z1 and Z2 as shown in FIG. 7B, and products 31 whose product category is “rice ball” are displayed in the zone Z1, and products 32 whose product category is “sandwich” are displayed in the zone Z2. In this case, the ratio of the SKU numbers of the products 31 and the products 32 which can be displayed changes depending on the ratio of the zone Z1 and the zone Z2. In other words, moving the border line between the zone Z1 and the zone Z2 changes the ratio of the SKU numbers of the products 31 and the products 32 which can be displayed on the display rack 201. That is, as the proportion of the zone Z1 increases, the SKU number of the products 31 which can be displayed on the display rack 201 increases, and the SKU number of the products 32 decreases.

In the shelf allocation adjustment P2, a proper SKU for each product category is obtained, thereby making the shelf allocation proper as explained above. That is, in the example shown in FIG. 7B, the SKU number of the products 31 whose product category is “rice ball” and the SKU number of the products 32 whose product category is “sandwich” are made proper, and thereby, the ratio of the zone Z1 and the zone Z2 in the display rack 201 can be made proper.

Here, the process of the shelf allocation adjustment P2 in the present embodiment includes step S2 of calculating a shelf allocation restriction and step S3 of making the shelf allocation proper as shown in FIG. 5.

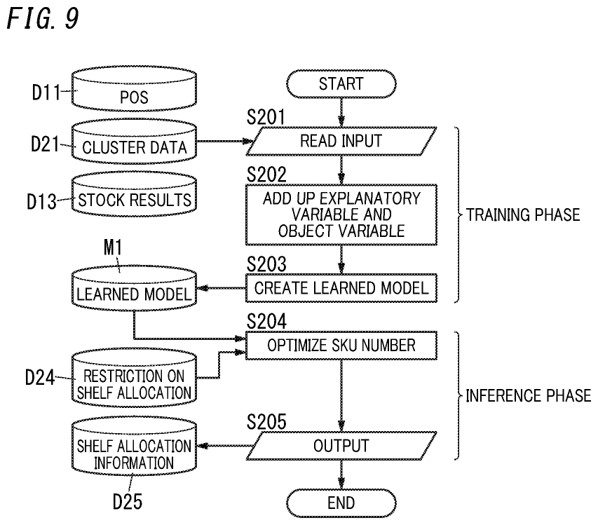

Step S2 includes calculating the restriction on the SKU number for each product category. Specifically, a maximum value of the SKU number (maximum SKU number) and a minimum value of the SKU number (minimum SKU number) are calculated for each product category. Thus, for making the shelf allocation proper, an adjustable range of the SKU number can be restricted for each product category. Step S2 includes calculating a shelf allocation restriction D24 (see FIG. 9) based on a reference value D12. Here, the reference value D12 is, for example, information which is delivered from the head office terminal 51 or the like and which defines a value to be used as a reference of the SKU number for each product category. The reference value D12 may include, for example, a list of products 3 which can be ordered in the target store 20, a list of sales promotion products promoted by the chain store head office 5, and a list of products 3 in stock.

Specifically, for example, the maximum SKU number is calculated such that the SKU number of a product category does not exceed the SKU number of the products 3 which can be supplied (ordered) in this product category.

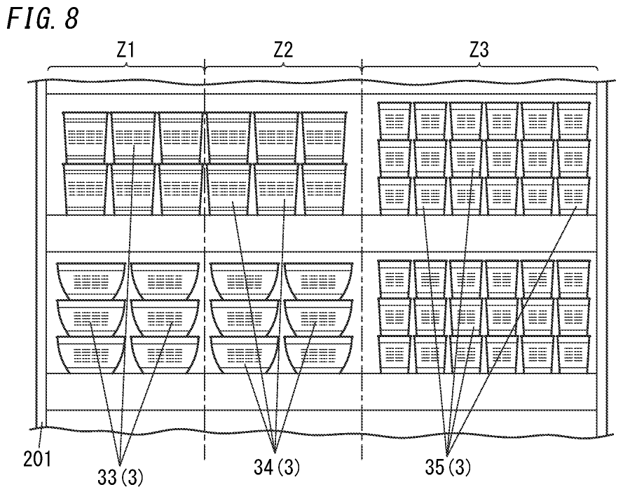

Moreover, for calculation of the shelf allocation restriction D24, the size of each product 3 is taken into consideration in the present embodiment. That is, as shown in FIG. 8, the size of each product 3 may restrict the shelf allocation. In the example shown in FIG. 8, products 33 belonging to product category “instant ramen”, products 34 belonging to product category “instant noodle made from wheat flour”, products 35 belonging to product category “cup-a-soup” which are convenience food are displayed on the display rack 201. In this case, the ratio of the SKU numbers of the products 33, products 34, and the products 35 which can be displayed changes depending on the ratio of the zone Z1, zone Z2, and zone Z3.

Here, the standard size of each of the products 33 and the products 34 is greater than the standard size of the products 35. Therefore, the SKU number of each of the products 33 or the products 34 which can be displayed is different from the SKU number of the products 35 which can be displayed even when the areas have the same size. Thus, for example, when the SKU number of the products 33 which can be displayed in the zone Z1 is increased by “1”, the SKU number of the products 35 which can be displayed in the zone Z3 has to be adjusted by being reduced by “2”. Thus, between the products 35 and a set of the products 33 and the products 34, a restriction on the ratio of the SKU numbers is defined, where the standard size of each of the products 33 and the products 34 is different from that of the products 35. For example, between product categories having different standard sizes, the ratio between the two categories is restricted such that the ratio of their SKU numbers is within a predetermined range (e.g., ±several %) based on a reference ratio. Between the products 33 and the products 34 which have the same standard size, such a restriction on the ratio of the SKU numbers is not defined.

Step S3 of making the shelf allocation proper includes calculating the shelf allocation information D25 for each product category based on the shelf allocation restriction D24 thus set. In step S3, for example, the cluster data D21, the POS data D11 and stock results D13 of the last one month are used for the target store 20 in addition to the shelf allocation restriction D24. The stock results D13 includes, for example, results of a stock, disposal, stock-out, and the like for each product 3 of the last one month or the same month a year ago.

Here, in step S3, the estimation unit 11 estimates, based on the learned model M1, the management index by using at least operation information as input information. The operation information is, for example, the SKU number for each product category in the target store 20. The management index is, for example, the sales amount for each product category in the target store 20.

Moreover, in step S2, the SKU of any product 3 may be extracted in the target store 20, for example, based on the POS data D11 of the last one month. Examples of an extraction method of the product 3 include: a method of extracting a product 3 for which a result value, such as the purchase number or the purchase frequency, within a prescribed time period is greater than or equal to a prescribed value; and a method of extracting a product 3 for which the result value is in a higher rank in the store 20. Moreover, an aggregate calculation target of the result value at this time may be all the customers 4 of the store 20 or some customer groups extracted based on the attribute, use frequency, cluster, or the like.

FIG. 9 is a flow chart showing a more detailed process procedure of the store supporting system 10 for step (S3) of making the shelf allocation proper.

That is, step S3 is roughly divided into: steps S201 to S203 corresponding to a “learning phase” for generating the learned model M1; and steps S204 to S205 corresponding to an “inference phase” in which estimation is performed based on the learned model M1.

First of all, in step S201, the POS data D11, the cluster data D21, and the stock results D13 are read as input data. In step S202, from the input data thus read, an explanatory variable and an object variable are added up for each store 2. In step S203, the learned model M1 is generated based on the explanatory variable and the object variable which have been added up.

In the present embodiment, for example, operation information (here, the SKU number) by product category and the cluster data D21 are used as the explanatory variable. On the other hand, the object variable is, for example, the sales amount for each product category. The explanatory variable and the object variable are added up for each store 2 with a store ID being used as a key.

This generates the learned model M1 for estimating the management index (here, the sales amount) by using the operation information for each product category (here, the SKU number) as input information. processes in the learning phase will be described also in “(3.6) Operation of Learning Device”.

Steps S204 to S205 according to the inference phase are executed for each store 2. That is, in the present embodiment, steps S204 to S205 are executed for at least the target store 20.

First of all, in step S204, the management index (here, the sales amount) is estimated, based on the learned model M1, by using the operation information (here, the SKU number) as the input information. At this time, for example, a search algorithm such as hill climbing is used to search the extreme value (peak value) of the management index. That is, in step S204, the SKU number when the sales amount is maximum is calculated as the shelf allocation information for each product category. The search algorithm used herein is not limited to the hill climbing but may be, for example, a branch and bound method or Bayesian optimization. Moreover, in step S204, information such as the shelf allocation restriction D24 is used, and thereby, an adjustable range of the SKU number is restricted for each product category.

In step S205, the shelf allocation information D25 is output. The shelf allocation information D25 thus obtained is information recommendable in connection with the product configuration of the target store 20 and may be included in the “recommendation information”. The shelf allocation information D25 preferably further includes the management index (here, the sales amount) estimated in step S204 in addition to the SKU number.

That is, in steps S204 to S205, the estimation unit 11 estimates, based on the learned model M1, the management index by using the operation information as input information, and then, the output unit 13 obtains, based on the result of estimation by the estimation unit 11, the shelf allocation information D25 as the recommendation information and outputs the shelf allocation information D25. Thus, the recommendation information (shelf allocation information D25) which is information relating to the operation of the target store 20 and which is recommendable for the target store 20 is obtained.

As described above, the estimation unit 11 further uses, as input information, auxiliary information for improving the estimation accuracy in addition to the operation information. The “auxiliary information” includes, for example, information on the purchase trend in the target store 20. More specifically, the information on the purchase trend included in the auxiliary information includes pieces of information on the purchase trends of the respective customers 4 in the target store 20. Moreover, the information on the purchase trend included in the auxiliary information includes a plurality of pieces of information on the plurality of clusters C1. The plurality of clusters C1 are obtained by classifying a data group including purchase histories of products 3 in the plurality of stores 2 in accordance with a rule about the purchase trend of the products 3 into the plurality of clusters C1. That is, in the present embodiment, in step S3 of making the shelf allocation proper, for example, for the target store 20, the cluster data D21, the POS data D11, the stock results D13, and the like of the last one month are used as pieces of auxiliary information. The pieces of auxiliary information correspond to pieces of information on the purchase trends of the respective customers 4 in the target store 20. Moreover, the cluster data D21 corresponds to the plurality of pieces of information on the plurality of clusters C1.

Moreover, as described above, the estimation unit 11 preferably further uses, as input information, a restriction condition that defines a restriction on the operation information in addition to the operation information. That is, step S204 of estimating, based on the learned model M1, the management index by using the operation information as input information adopts the shelf allocation restriction D24 to restrict the adjustable range of the SKU number for each product category. The shelf allocation restriction D24 is information defining a restriction on the operation information (e.g., SKU number) and is thus included in the “restriction condition”.

Here, the restriction condition includes a condition relating to the size of each of a plurality of products 3. That is, the shelf allocation restriction D24 (restriction condition) is calculated in consideration of the size of each product 3 in the present embodiment, and a restriction is defined on the ratio of the SKU number between the products 3 having different standard sizes. Thus, by using, as input information, the shelf allocation restriction D24 which is a restriction condition, the estimation unit 11 can estimate the management index (e.g., sales amount) with the operation information (e.g., the SKU number) being restricted by a condition relating to the size of each of the plurality of products 3.

Moreover, the restriction condition includes a condition that defines at least one of a maximum value or a minimum value of the SKU number or the number of items in one product category. That is, the shelf allocation restriction D24 (restriction condition) of the present embodiment includes, for each product category, a maximum value of the SKU number (maximum SKU number) and a minimum value of the SKU number (minimum SKU number). Thus, by using, as input information, the shelf allocation restriction D24 which is a restriction condition, the estimation unit 11 can estimate the management index (e.g., sales amount) with the SKU number or the number of items in one product category being restricted.

Incidentally, in the inference phase, the operation information (here, SKU number) used as input information to be input to the estimation unit 11 may be subdivided information when compared to the management index (here, the sales amount) to be used as an output. For example, when the operation information is the SKU number for each product category, and the management index is the sales amount for each product category, the product categories for the operation information is more finely subdivided than the product categories for the management index. In this case, for example, the product category for the operation information (SKU number) is a “small category”, whereas the product category for the management index (sales amount) is a “medium category”.

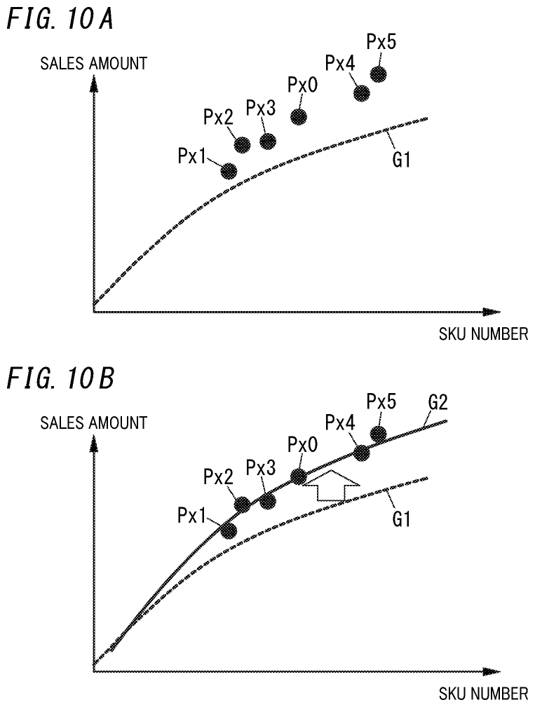

Moreover, the learned model M1 used in step S204 is preferably corrected based on the result data of the target store 20. That is, modifying the learned model M1 for the target store 20 as exemplified in FIGS. 10A and 10B can improve the accuracy of estimation by the estimation unit 11 based on the learned model M1. FIGS. 10A and 10B are graphs, where the abscissa represents the SKU number, and the ordinate represents the sales amount.

For example, it is assumed that in a product category, the relationship between the SKU value and the sales amount estimated based on the learned model M1 is represented by the graph G1 as shown in FIG. 10A. In contrast, pieces of result data Px0 to Px5 of the target store 20 are, as shown in FIG. 10A, present at locations deviated from the graph G1. Here, the pieces of result data Px0 to Px5 respectively show pieces of result data of the present month, one month before the present month, two months before the present month, three months before the present month, four months before the present month, and five months before the present month.

In this case, in order to reduce the difference of these pieces of result data Px0 to Px5 from the graph G1, a correction factor is obtained based on the pieces of result data Px0 to Px5 and the graph G1, which enables the learned model M1 to be corrected. That is, the relationship formula (graph G1) between the SKU number estimated based on the learned model M1 and the sales amount is corrected by the correction factor, thereby obtaining a corrected learned model M1. According to the corrected learned model M1, as shown by the graph G2 in FIG. 10B, the relationship between the SKU number and the sales amount comes close to the pieces of result data Px0 to Px5 of the target store 20. Consequently, using the corrected learned model M1 improves the accuracy of estimation by the estimation unit 11.

Moreover, in the example shown in FIG. 10B, for obtaining the correction factor, a weighting coefficient is preferably set for each of the plurality of pieces of result data Px0 to Px5. That is, the weighting coefficient is set, depending on a month to which the result data belongs, such that the result data of a month closer to the present month is preferentially reflected to the correction factor. For example, the weighting coefficient of the result data Px0 of the present month is set as an initial value “1.0”, and for each month backward from the present month, a value multiplied by “0.7” is used as the weighting coefficient. In this case, for example, for the result data Px2 of two months before the present month, the weighting coefficient is “0.49” (=1.0×0.7×0.7). As described above, in time series, a larger weighting coefficient is set to the result data of a month closer to the present (present month), and thereby, a correction factor that weights the result data of a month closer to the present (present month) can be obtained.

Moreover, information which is used, as a means of improving the accuracy of estimation by the estimation unit 11, for generation of the learned model M1 and which relates to the operation of the store 2 may effectively include, for a specific product category, information in a target time period in the past in a specific relationship with the present. That is, information used for generation (machine learning) of the learned model M1 is not information at any time point in the past but is preferably information in the target time period in the past in a specific relationship with the present. As used herein “the target time period in the past in the specific relationship with the present” is a time period in the past in any correlation relationship with the “present month” corresponding to the present and is, for example, the same month in the previous year or in the year prior to the previous year (including the same month a year ago or the same month two years ago) or the last month (the nearest month in the same year). Thus, the learned model M1 is generated based on information in the target time period in a correlation relationship with the present (present month), and thereby, the accuracy of the estimation based on the learned model M1 is improved. For example, when the same month in the previous year or in the year prior to the previous year is set as the target time period, estimation strongly reflecting the influence of, for example, seasons or weather becomes possible, whereas when the last month is set as the target time period, estimation strongly reflecting the influence of, for example, a trend and a consumption trend becomes possible.

Moreover, as a means of improving the accuracy of estimation by the estimation unit 11, a plurality of learned models M1 are effectively used selectively. For example, as described above, when a learned model M1 generated based on the same month in the previous year or in the year prior to the previous year set as the target time period and a learned model M1 generated based on the last month set as the target time period are available, these two learned models M1 may be selectively used. That is, the estimation unit 11 selectively uses a learned model M1 of the plurality of learned models M1 which has a relatively high estimation accuracy, thereby improving the estimation accuracy of the estimation unit 11.

(3.4) Ranking Creation

Next, the process of the ranking creation P3 will be described in more detail with reference to FIGS. 4 and 5.

In the ranking creation P3, the plurality of recommended products in the target store 20 are ranked, for example, for each product category. In addition, in the ranking creation P3, trend information such as a component ratio of the plurality of clusters C1 in the target store 20 is taken into consideration to create the ranking D29 of the recommended products in product category “rice ball” in the target store 20. That is, the ranking D29 based on the trend information (component ratio of the plurality of clusters C1) of the target store 20 is created.

For example, the product category “rice ball” is assumed to include a plurality of products 3 (SKUs) including “Japanese plum”, “salmon”, “kelp”, “spicy cod roe”, “tuna mayonnaise”, “shavings of dried bonito”, and the like. In this case, it is assumed from the component ratio of the plurality of clusters C1 in the target store 20 that most of the customers 4 of the target store 20 are made up of a cluster C1 of customers 4 who frequently purchase “Japanese plum” and a cluster C1 of customers 4 who frequently purchase “spicy cod roe”. In this case, “Japanese plum” and “spicy cod roe” are ranked high in the ranking D29 of the recommended products in the product category “rice ball” in the target store 20.

Here, the process of the ranking creation P3 in the present embodiment includes step S4 of calculating the sales amount for each cluster C1 and step S5 of calculating the sales amount for each store 2 as shown in FIG. 5. The process of the ranking creation P3 further includes step S6 of calculating an expected sales amount of a new product.

In step S4, for example, an expected sales amount for each cluster C1 is calculated based on the POS data D11, the cluster data D21, and the stock results D13 of the last one month. An expected sales amount by cluster is thus calculated. Here, the amount of money which would be spent for one month by a customer 4 affiliated with a cluster C1 if the customer 4 visits a store 2 selling products 3 of a SKU is calculated as the expected sales amount by cluster. In order to do this, basically, for each cluster C1, the total amount of money spent in the store 2 for one month is divided by the number of customers 4 included in the cluster C1. The expected sales amount by cluster is thus calculated. More specifically, the expected sales amount by cluster is calculated in consideration that that one customer 4 is affiliated with a plurality of clusters C1 and whether or not the products 3 are in stock in the store 2.

In step S5, an expected sales amount for each store 2 is calculated based on the expected sales amount by cluster obtained in step S4 and the cluster data D21. Thus, the expected sales amount by store is calculated.

In step S6, the expected sales amount of the new product is calculated, and the new products and existing products are merged, thereby creating the ranking D29 which is a final ranking. Thus, the ranking D29 with the new product and the existing products being merged is created.

Incidentally, for calculation of the expected sales amount of the new product, the calculation accuracy of the expected sales amount of the new product may not be able to be satisfactorily secured due to unsatisfactory sales results of the new product in the target store 20. As a countermeasure, when the recommended products include an unhandled product which is not handled in the target store 20, the rank order of the unhandled product is preferably determined based on the similarity between any handled product and the unhandled product in the target store 20. As used herein, the “similarity” means comprehensive similarity in, for example, the genre, the component, the taste, the concept (e.g., a premium product), the target customer segment, the price zone, or the like of products 3. For example, when two products 3 which are both in a small category “green tea” in terms of the product category and which are the same in terms of the target customer segment or the price zone are sold by different manufacturers, the similarity of these two products 3 is high. Suppose, for instance, that one product of the products 3 with high similarity is an unhandled product (new product). In this case, the rank order of the one product is determined based on the rank order of the other product 3 (existing product) handled in the target store 20.

Specific examples of a means of determining the rank order of the unhandled product may be examples as described below. A first means is that a rank order the same as the rank order of a product 3 which is one of handled products 3 (existing products) in the target store 20 and which has the highest similarity to the unhandled product is adopted as the rank order of the unhandled product. A second means is that when an unhandled product is a newly marketed product 3, the rank order of the unhandled product is determined in consideration of a sales increasing effect due to a new release in addition to the sales of the product 3 which is one of handled products 3 (existing products) in the target store 20 and which has the highest similarity to the unhandled product. That is, for the newly marketed product 3, for example, the sales increasing effect according to the number of days elapsed from the new release can be expected. For example, the sales is expected to increase by 3 times in first week, 2 times in the second weeks, and 1.5 times in the third weeks from the new release. Thus, the sales increasing effect according to the number of days elapsed from the new release is used as a correction factor, and the sales of the product 3 having the highest similarity is multiplied by the correction factor, thereby estimating the sales amount of the unhandled product. From the obtained sales amount of the unhandled product, the rank order of the unhandled product can be determined.

A third means is that the average rank order of N products 3 counted, in descending order of the similarity to the unhandled product, up to the Nth product 3 (where N is an integer greater than or equal to 2) of handled products 3 (existing products) in the target store 20 is adopted as the rank order of the unhandled product. In this case, the rank order of the unhandled product may be determined in consideration of a sales increasing effect due to a new release in addition to the average sales of the N products 3 in a similar manner to the second means. A fourth means is that an average rank order of N products 3 whose similarities to the unhandled product are each greater than or equal to a certain value (where N is an integer greater than or equal to 1) of handled products 3 (existing products) in the target store 20 is adopted as the rank order of the unhandled product. In this case, the rank order of the unhandled product may be determined in consideration of a sales increasing effect due to a new release in addition to the average sales of the N products 3 in a similar manner to the second means.

(3.5) Listing

Next, the process of the listing P4 will be described in more detail with reference to FIGS. 4 and 5.

In the listing P4, a list of the recommended products as the recommendation information D30 is created based on the shelf allocation information D25 obtained by the shelf allocation adjustment P2 and the ranking D29 obtained by the ranking creation P3. That is, for each product category, the shelf allocation information D25 and the ranking D29 are combined with each other, and thereby, products 3 in rank orders up to the optimal SKU number in descending order in the ranking may be listed up as the recommended products. The recommendation information D30 created in this way includes recommended product information on the recommended products for each product category. Moreover, in the present embodiment, the recommendation information D30 includes recommended product information on a plurality of recommended products and recommendation rank order information on the rank orders of the plurality of recommended products. The recommendation rank order information is created for each product category.

More specifically, the recommendation information D30 includes the ranking D29 merged by the operation information (SKU number for each product category) included in the result of estimation by the estimation unit 11. That is, it is, first of all, provided that the result of estimation by the estimation unit 11 includes a correspondence relationship between an input (the operation information) and an output (the management index), and thus, “operation information” that can provide a preferable management index can be identified. The output unit 13 does not obtain the recommendation information D30 from only the result of estimation by the estimation unit 11 but merely uses the result of estimation by the estimation unit 11 to obtain the recommendation information D30.

That is, in the present embodiment, separately from the estimation result obtained based on the learned model M1, there is the ranking D29 obtained based on the plurality of clusters C1. To the output unit 13, not only the result of estimation by the estimation unit 11 but also the ranking D29 is input. The output unit 13 merges the ranking D29 by the operation information (SKU number for each product category) included in the result of estimation by the estimation unit 11, thereby generating the recommendation information D30.

Here, the process of the listing P4 in the present embodiment includes step S7 of correcting the ranking D29 obtained by the ranking creation P3 and step S8 of integrating pieces of recommendation information as shown in FIG. 5.

In step S7, the ranking D29 is corrected based on a product list D16. Here, the product list D16 may include a list of products 3 which can be ordered in the target store 20, a list of sales promotion products promoted by the chain store head office 5, a list of products 3 in stock, and the like which are pieces of information to be distributed from, for example, the head office terminal 51. By using the product list D16 as described above, the ranking D29 is corrected in consideration of whether or not an order in the target store 20 is possible.

In step S8, the pieces of recommendation information are integrated based on the ranking D29 corrected in step S7 and the shelf allocation information D25, thereby creating a list of the recommended products for each product category. At this time, the SKU number for each product category is determined based on the shelf allocation information D25.

Thus, the recommendation information D30 is output which includes, for the target store 20, the recommended product information on the plurality of recommended products and the recommendation rank order information on the rank orders of the plurality of recommended products for each product category.

As described above, in the present embodiment, each of the operation information and the recommendation information D30 includes information on the product configuration in the target store 20. That is, in the present embodiment, the operation information is, for example, the SKU number for each product category in the target store 20 and thus includes the information on the product configuration in the target store 20. In contrast, the recommendation information D30 includes the recommended product information on the plurality of recommended products and the recommendation rank order information on the rank orders of the plurality of recommended products and thus includes the information on the product configuration in the target store 20.

Moreover, the recommendation information D30 is information which is based on primary information calculated from the trend information and which is corrected by using correction information different from the trend information. That is, the recommendation information D30 is not the primary information itself calculated from the trend information but is information obtained by performing any correction (process) on the primary information by using the correction information. The ranking D29 in the present embodiment is generated based on the trend information (component ratio of the plurality of clusters C1) of the target store 20 as described above, and therefore, the ranking D29 corresponds to the primary information. In contrast, the ranking D29 is corrected by using the shelf allocation information D25, the product list D16, and the like as the correction information, thereby generating the recommendation information D30. That is, information corrected, on the basis of the ranking D29, by using the correction information is the recommendation information D30.

(3.6) Operation of Learning Device
Next, operation of the learning device 110 (learning machine), that is, a generation method of the learned model M1 will be described.

The learning device 110 is configured to generate the learned model M1 by machine learning with data, as the training data D1, including information on the operation of the store 2 and an index relating to the management of the store 2. That is, the learned model M1 to be used for the estimation of the management index is generated from the training data D1 including the information on the operation and the index relating to the management of a stores 2 other than the target store 20. Here, an algorithm of the machine learning applied by the learning device 110 is, for example, a multiple regression analysis.

Moreover, information included in data (explanatory variable) input to the estimation unit 11 in the inference phase is preferably included in the training data D1 input to the learning device 110 also in the learning phase. For example, in the inference phase, information, specifically, the cluster data D21 (information on the purchase trend), or the like, used as auxiliary information improving the estimation accuracy is preferably included in the training data D1 input to the learning device 110 in an input phase.

Moreover, the explanatory variable used in the learning phase is not limited to the cluster data D21 and the like but may include other information and the like.

(4) Variation

The first embodiment is merely one of various embodiments of the present disclosure. Various modifications may be made to the first embodiment depending on design and the like as long as the object of the present disclosure is achieved. Moreover, functions similar to the store supporting system 10 according to the first embodiment may be implemented by a store supporting method, a computer program, a non-transitory storage medium storing a computer program, or the like. A store supporting method according to an aspect includes an estimation process and an output process. The estimation process is a process of estimating, based on a learned model M1, a management index by using at least operation information as input information. The operation information is information on operation of a target store 20 which is a specific store 2. The management index is an index relating to management of the target store 20. The learned model M1 is generated by machine learning with data, as the training data D1, including information on operation of a store 2 and an index relating to management of the store 2. The output process is a process of obtaining, based on a result of estimation by the estimation unit 11, recommendation information D30 and outputting the recommendation information D30. The recommendation information D30 is information relating to the operation of the target store 20 and is recommendable for the target store 20.

Moreover, a store supporting method according to another aspect includes a calculation process and an output process. The calculation process is a process of obtaining, based on a plurality of clusters C1, trend information on a purchase trend of products 3 in a target store 20 which is a specific store 2. The plurality of clusters C1 are obtained by classifying a data group including purchase histories of products 3 in the plurality of stores 2 in accordance with a rule about the purchase trend of the products 3 into the plurality of clusters C1. The output process is a process of obtaining, based on the trend information, recommendation information D30 and outputting the recommendation information D30. The recommendation information D30 is information relating to the operation of the target store 20 and is recommendable for the target store 20.

A generation method of a learned model M1 according to an aspect is a generation method of a learned model M1 to be used in a store supporting system 10. The store supporting system 10 is configured to estimate a management index by using at least operation information as input information. The operation information is information on operation of a target store 20 which is a specific store 2. The management index is an index relating to management of the target store 20. The generation method of the learned model M1 includes generating the learned model M1 by machine learning with data which is input as training data D1 and which includes information on operation of a store 2 and an index relating to management of the store 2.

A program according to an aspect of the present disclosure is a program configured to cause one or more processors to execute any one of the store supporting methods, or the generation method of the learned model M1.

Variations of the first embodiment will be described below. The variations to be described below may be adopted in combination as appropriate.

In the store supporting system 10 in the present disclosure, the server device 1, and the like include respective computer systems. The computer system includes, as principal hardware components, a processor and a memory. The processor executes a program stored in the memory of the computer system, thereby implementing the function as the store supporting system 10 of the present disclosure. The program may be stored in advance in the memory of the computer system. Alternatively, the program may also be downloaded through a telecommunications network or may be distributed after having been recorded in some non-transitory storage medium such as a memory card, an optical disc, or a hard disk drive, any of which is readable for the computer system. The processor of the computer system may be implemented as a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very large-scale integrated circuit (VLSI), and an ultra large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. The plurality of chips may be collected in one device or may be distributed in a plurality of devices. As mentioned herein, the computer system includes a microcontroller including one or more processors and one or more memories. Thus, the microcontroller may also be implemented as a single or a plurality of electronic circuits including a semiconductor integrated circuit or a large-scale integrated circuit.

Collecting the plurality of functions in the store supporting system 10 in one housing is not an essential configuration of the store supporting system 10. The components of the store supporting system 10 may be distributed in a plurality of housings. Moreover, at least some functions of the store supporting system 10, for example, some functions of the server device 1 or the like, may be implemented by cloud (cloud computing) or the like.

In contrast, in the first embodiment, at least some functions of the store supporting system 10 distributed in a plurality of devices may be collected in one housing. For example, some functions of the store supporting system 10 distributed in the server device 1 and the POS system 21 may be collected in one housing.

Moreover, the application of the store supporting system 10 is not limited to application in convenience stores, but the store supporting system 10 may be introduced in stores 2 other than convenience stores.

Moreover, a user interface in, for example, the store terminal 22 or the like is not limited to the touch screen but may include an input device such as a keyboard, a pointing device, a mechanical switch, or a gesture sensor. In addition, the user interface may include a display device such as a projector or the like configured to project video images by, for example, a projection mapping technique. Moreover, the user interface may include a voice input/output unit in place of the touch screen or together with the touch screen. In this case, the user interface is able to provide sales clerks and the like with various types of information by voice output from a loudspeaker. Moreover, the user interface applies speech recognition and semantic analysis to a voice signal output from a microphone to allow the sales clerks and the like to perform an operation (voice input) by voice.

Moreover, in the first embodiment, the output unit 13 obtains the recommendation information in accordance with both the result of estimation by the estimation unit 11 and the trend information calculated by the calculator 12. However, this configuration is not an essential configuration for the store supporting system 10. That is, the output unit 13 at least obtains the recommendation information in accordance with at least one of the result of estimation by the estimation unit 11 or the trend information calculated by the calculator 12. For example, the output unit 13 may obtain the recommendation information in accordance with only the result of estimation by the estimation unit 11. In this case, the recommendation information includes the SKU number for each product category but does not include the rank orders or the like of the recommended products. Alternatively, the output unit 13 may obtain the recommendation information in accordance with only the trend information calculated by the calculator 12. In this case, the recommendation information includes the rank order of the recommended products but does not include the SKU number or the like for each product category.

Moreover, the information on the product configuration used as the operation information or the like is not limited to the SKU number for each product category. The information on the product configuration may include at least one of, for example, the number of items for each product category, the number of faces for each product category, the stocking number for each product category, the number of shelves for each product category, the number of faces of each product 3, or the stocking number of each product 3. Naturally, the information on the product configuration may include the SKU number for each product category in addition to the above-mentioned numbers.

Moreover, the auxiliary information to be input to the estimation unit 11 to improve the accuracy of estimation by the estimation unit 11 is not limited to a configuration including information on the purchase trend of each customer 4 in the target store 20, as information on the purchase trend. That is, the information on the purchase trend included in the auxiliary information may include information on the purchase trend of each checkout process in the target store 20, for example. In sum, even in the case of an identical customer 4, if the customer 4 uses the target store 20 several times a day, the purchase trend can be reflected in more detail in units of one checkout process than in units of the customer 4. Similarly, the information on the purchase trend included in the auxiliary information may include, for example, information on the purchase trend of each store 2, or information on the purchase trend in each time zone or on each day of the week.

Moreover, regarding the clustering, a soft (fuzzy) cluster C1 is adopted in the first embodiment, but this should not be construed as limiting. Alternatively, a hard (crisp) cluster C1 may be adopted. In this case, one customer 4 is affiliated with any one of the plurality of clusters C1.

Moreover, the style of selling products 3 in the store 2 is not limited to the style of selling the plurality of products 3 in a displayed state in the store as in the first embodiment. For example, a vending machine which stores products 3 may be used, and a checkout process of and dispensing of a product 3 of the products 3 which is selected by a customer 4 may be performed, thereby selling the product 3. Moreover, even in the style of selling the plurality of products 3 in the displayed state in the store, a customer 4 may perform a checkout process by using, for example, a self-checkout counter with no intervention by a sales clerk.

Moreover, the first embodiment proposes, as a means of improving the management index of the target store 20, the recommendation information for making the product configuration of the products 3 in the target store 20 proper. Therefore, the first embodiment adopts, as the operation information, information (e.g., the SKU number for each product category) on the product configuration of the target store 20. However, the operation information is at least information on the operation of the target store 20 but is not limited to the information on the product configuration of the target store 20. For example, the operation information may include information on a store layout, a Point of Purchase (POP) advertisement, a campaign, hours of operation, or the like. The “store layout” as used herein includes, for example, a physical layout of display racks, counters, and the like, a layout of circulation, a layout of a dining area and the like, and a layout of products 3 displayed on the display racks in the target store 20.

Moreover, the first embodiment proposes, as a means of improving the management index of the target store 20, the recommendation information mainly for increasing the sales amount of the target store 20 by making the product configuration of the products 3 in the target store 20 proper. Therefore, the first embodiment adopts, as the management index, information (e.g., the sales amount for each product category) on the sales amount of the target store 20. Note that the management index is at least information on the management of the target store 20 but is not limited to the sales amount or the like in each product category. For example, the management index is not limited to the sales amount but may be a customer unit price or an average value of LTVs. Alternatively, the management index may be information on the sales amount of each store (i.e., the entirety of the target store 20), of each checkout process, or in each time zone. Moreover, the management index may be information such as the profit, the number of customers, the number of heavy users, the repeat rate of the customer 4, the number of new customers, the stay time of the customer 4, or the like which does not directly relate to the sales amount.

Moreover, the training data D1 used to generate the learned model M1 includes at least the information on the operation of one or more stores 2 and the index on the management of the one or more stores 2. Here, the one or more stores 2 from which the training data D1 is extracted may, but does not have to, include the target store 20. That is, in the former case, the learned model M1 is generated by using the training data D1 extracted from the one or more stores 2 including the target store 20.

Moreover, the “shelf allocation” to be made proper by the store supporting system 10 is not limited to matters such as how many products 3 are to be displayed on the display rack 201, but the “shelf allocation” may include matters such as “where” on the display rack 201 and how many products 3 are to be displayed. That is, the store supporting system 10 may make the layout of shelf allocation proper. Examples of the layout include where on the display rack 201 and how many products 3 are to be displayed.

### Second Embodiment

A store supporting system 10 according to the present embodiment is different from the store supporting system 10 of the first embodiment in that a plurality of clusters C1 are pieces of data obtained by classifying a data group in units of a checkout process.

That is, in the first embodiment, the plurality of clusters C1 are pieces of data obtained by classifying the data group in units of the customer 4. In contrast, in the present embodiment, the data group is classified in units of the “checkout process”, thereby providing the plurality of clusters C1. In sum, even in the case of an identical customer 4, if the customer 4 uses a target store 20 several times a day, the clusters C1 reflecting the purchase trend in more detail can be generated in units of one checkout process than in units of the customer 4.

As a variation of the second embodiment, the plurality of clusters C1 may be pieces of data obtained by classifying the data group in units of the store 2. In this case, the purchase trends of a plurality of customers 4 who use an identical store 2 are collectively classified into one identical cluster C1, and the purchase trend as a whole of the store 2 is easily reflected to the cluster C1.

In the case of classifying the data group in units of the checkout process or in units of the store 2, the explanatory variable for clustering is information on, for example, the sales amount by product category, the attributes (e.g., ages and gender) of customers 4, the environment around the store 2, the location and the layout of the store 2, and the like. That is, in the present embodiment, the plurality of clusters C1 are plurality of data obtained by classifying, based on the sales amount by product category, attributes (e.g., ages and gender) of the customers 4, and the like, the data group in units of the checkout process or in units of the store 2.

The various configurations (including the variation) described in the second embodiment are adoptable accordingly in combination with the various configurations (including the variation) described in the first embodiment.

(Summary)

As described above, a store supporting system (10) of a first aspect includes an estimation unit (11) and an output unit (13). The estimation unit (11) is configured to estimate, based on a learned model (M1), a management index by using at least operation information as input information. The operation information is information on operation of a target store (20) which is a specific store (2). The management index is an index relating to management of the target store (20). The learned model (M1) is generated by machine learning with data, as training data (D1), including information on operation of a store (2) and an index relating to management of the store (2). The output unit (13) is configured to obtain, based on a result of estimation by the estimation unit (11), recommendation information (D30) and output the recommendation information (D30). The recommendation information (D30) is information relating to the operation of the target store (20) and is recommendable for the target store (20).

This aspect provides the recommendation information (D30), for example, as information which leads to an improvement in the sales amount of the target store (20) and consequently to an improvement in the financial condition of the target store (20) and which is recommendable about the operation of the target store (20). Here, the management index used to obtain the recommendation information (D30) is estimated based on the learned model (M1) by using at least operation information as input information. The learned model (M1) is generated from the training data (D1) including one or more pieces of information on operation of, and one or more indexes relating to management of, one or more stores (2), and therefore, the management index is estimated based on one or more pieces of result data of the one or more stores (2). Consequently, the store supporting system (10) provides the advantage that the operation of the target store (20) is easily properly supported.

In a store supporting system (10) of a second aspect referring to the first aspect, the estimation unit (11) is configured to further use, as input information, auxiliary information for improving an accuracy of the estimation in addition to the operation information.

With this aspect, the accuracy of estimation of the management index is improved.

In a store supporting system (10) of a third aspect referring to the second aspect, the auxiliary information includes information on a purchase trend in the target store (20).

With this aspect, the accuracy of estimation of the management index is improved.

In a store supporting system (10) of a fourth aspect referring to the third aspect, the information on the purchase trend includes information on a purchase trend of each of a plurality of customers (4) in the target store (20).

With this aspect, the accuracy of estimation of the management index is improved.

In a store supporting system (10) of a fifth aspect referring to the third or fourth aspect, the information on the purchase trend include pieces of information on a purchase trend of each of a plurality of checkout processes in the target store (20).

With this aspect, the accuracy of estimation of the management index is improved.

In a store supporting system (10) of a sixth aspect referring to any one of the third to fifth aspects, the information on the purchase trend includes information on a plurality of clusters (C1). The plurality of clusters (C1) are obtained by classifying, based on a rule about a purchase trend of products (3), a data group including purchase histories of the products (3) in a plurality of stores (2) into the plurality of clusters (C1).

With this aspect, even a large amount of data is usable as the information on the purchase trend by classifying the large amount of data into the plurality of clusters (C1), thereby easily improving the accuracy of estimation of the management index.

In a store supporting system (10) of a seventh aspect referring to the sixth aspect, the plurality of clusters (C1) are reclassified based on a result of improvement in an index relating to the management of the target store (20), the result being calculated for each of the plurality of clusters (C1).

With this aspect, the plurality of clusters (C1) are easily made proper with reference to the management index.

In a store supporting system (10) of an eighth aspect referring to any one of the first to seventh aspects, each of the operation information and the recommendation information (D30) includes information on a product configuration in the target store (20).

With this aspect, the product configuration, which is recommendable as the recommendation information (D30), in the target store (20) can be presented.

In a store supporting system (10) of a ninth aspect referring to the eighth aspect, The information on the product configuration includes at least one of a SKU number for each of a plurality of product categories, a number of items for each of the plurality of product categories, a number of faces for each of the plurality of product categories, a stocking number for each of the plurality of product categories, a number of shelves for each of the plurality of product categories, a number of faces of each product (3), or a stocking number of each product (3).

With this aspect, a specific product configuration readily adopted by the target store (20) can be presented as the recommendation information (D30).

In a store supporting system (10) of a tenth aspect referring to the sixth aspect, the information which is used for generation of the learned model (M1) and which is on the operation of the store (2) includes information on a specific product category in a target time period in the past in a specific relationship with the present.

With this aspect, the learned model (M1) based on the information in a target time period in the past in a specific relationship with the present (e.g., the same season) is obtained, thereby improving the accuracy of estimation of the management index.

In a store supporting system (10) of an eleventh aspect referring to any one of the first to tenth aspects, the learned model (M1) is corrected based on result data of the target store (20).

With this aspect, the learned model (M1) is corrected for the target store (20), thereby improving the accuracy of estimation of the management index.

In a store supporting system (10) of a twelfth aspect referring to any one of the first to eleventh aspects, the recommendation information (D30) includes recommended product information on a plurality of recommended products and recommendation rank order information on orders of the plurality of recommended products.

With this aspect, specifically, the information on the plurality of recommended products, and in addition, the information on the rank orders of the plurality of recommended products can be presented as the recommendation information (D30).

In a store supporting system (10) of a thirteenth aspect referring to the twelfth aspect, when the recommended products include an unhandled product, a rank order of the unhandled product is determined based on similarity between the unhandled product and a handled product (3) in the target store (20). The unhandled product is a product (3) which is not handled in the target store (20).

With this aspect, even when the recommended products include the unhandled product, the rank order of the unhandled product is determined based on the products (3) similar to the unhandled product.

In a store supporting system (10) of a fourteenth aspect referring to any one of the first to thirteenth aspects, the estimation unit (11) is configured to further use, as input information, a restriction condition which defines a restriction on the operation information in addition to the operation information.

With this aspect, a restriction can be imposed on the operation information at the time of estimation of the management index.

In a store supporting system (10) of a fifteenth aspect referring to the fourteenth aspect, the restriction condition includes a condition relating to a size of each of a plurality of products (3).

With this aspect, at the time of estimation of the management index, a restriction can be imposed on the size of each of the products (3).

In a store supporting system (10) of a sixteenth aspect referring to the fourteenth or fifteenth aspect, the restriction condition includes a condition which defines at least one of a maximum value or a minimum value of a SKU number or a number of items in one product category.

With this aspect, at the time of estimation of the management index, a restriction can be imposed on the SKU number or the number of items.

A learning device (110) of a seventeenth aspect is configured to generate a learned model (M1) to be used in a store supporting system (10). The store supporting system (10) is configured to estimate a management index by using at least operation information as input information. The operation information is information on operation of a target store (20) which is a specific store (2). The management index is an index relating to management of the target store (20). The learning device (110) is configured to generate the learned model (M1) by machine learning with data which is input as training data (D1) to the learning device (110) and which includes information on operation of a store (2) and an index relating to management of the store (2).

This aspect provides the advantage that the operation of the target store (20) is easily properly supported.

A store supporting method of an eighteenth aspect includes an estimation process and an output process. The estimation process is a process of estimating, based on a learned model (M1), a management index by using at least operation information as input information. The operation information is information on operation of a target store (20) which is a specific store (2). The management index is an index relating to management of the target store (20). The learned model (M1) is generated by machine learning with data, as training data (D1), including information on operation of a store (2) and an index relating to management of the store (2). The output process is a process of obtaining, based on a result of estimation in the estimation process, recommendation information and outputting the recommendation information (D30). The recommendation information (D30) is information relating to the operation of the target store (20) and is recommendable for the target store (20).

This aspect provides the advantage that the operation of the target store (20) is easily properly supported.

A generation method of a learned model (M1) of a nineteenth aspect is the generation method of the learned model (M1) to be used in a store supporting system (10). The store supporting system (10) is configured to estimate a management index by using at least operation information as input information. The operation information is information on operation of a target store (20) which is a specific store (2). The management index is an index relating to management of the target store (20). The generation method of the learned model (M1) includes generating the learned model (M1) by machine learning with data which is input as training data (D1) and which includes information on operation of a store (2) and an index relating to management of the store (2).

This aspect provides the advantage that the operation of the target store is easily properly supported.

A program of a twentieth aspect is a program configured to cause one or more processors to execute the store supporting method of the eighteenth aspect or the generation method of the learned model (M1) of the nineteenth aspect.

This aspect provides the advantage that the operation of the target store (20) is easily properly supported.

Various aspects (including variations) of the store supporting system (10) according to the first embodiment and the second embodiment are not limited to the aspects described above but may be implemented as the learning device (110), the store supporting method, the generation method of the learned model (M1), the program, and a non-transitory recording medium storing the program.

The constituent elements according to the second to sixteenth aspects are not essential constituent elements for the store supporting system (10) but may be omitted as appropriate.

### REFERENCE SIGNS LIST

2 Store
3 Product
4 Customer
10 Store Supporting System
11 Estimation Unit
13 Output Unit
110 Learning Device
C1 Cluster
D1 Training Data
D30 Recommendation Information
M1 Learned Model

1. A store supporting system comprising:
an estimation unit configured to estimate, based on a learned model, a management index by using at least operation information as input information, the learned model being generated by machine learning with data, as training data, including information on operation of a store and an index relating to management of the store, the operation information being information on operation of a target store which is a specific store, the management index relating to management of the target store; and
an output unit configured to obtain, based on a result of estimation by the estimation unit, recommendation information and output the recommendation information, the recommendation information being information relating to the operation of the target store and being recommendable for the target store.

2. The store supporting system of claim 1, wherein
the estimation unit is configured to further use, as input information, auxiliary information for improving an accuracy of the estimation in addition to the operation information.

3. The store supporting system of claim 2, wherein
the auxiliary information includes information on a purchase trend in the target store.

4. The store supporting system of claim 3, wherein
the information on the purchase trend includes information on a purchase trend of each of a plurality of customers in the target store.

5. The store supporting system of claim 3, wherein
the information on the purchase trend includes information on purchase trend of each of a plurality of checkout processes in the target store.

6. The store supporting system of claim 3, wherein
the information on the purchase trend includes information on a plurality of clusters obtained by classifying, based on a rule about a purchase trend of products, a data group including purchase histories of the products in a plurality of stores into the plurality of clusters.

7. The store supporting system of claim 6, wherein
the plurality of clusters are reclassified based on a result of improvement in an index relating to the management of the target store, the result being calculated for each of the plurality of clusters.

8. The store supporting system of claim 1, wherein
each of the operation information and the recommendation information includes information on a product configuration in the target store.

9. The store supporting system of claim 8, wherein
the information on the product configuration includes at least one of a SKU number for each of a plurality of product categories, a number of items for each of the plurality of product categories, a number of faces for each of the plurality of product categories, a stocking number for each of the plurality of product categories, a number of shelves for each of the plurality of product categories, a number of faces of each product, or a stocking number of each product.

10. The store supporting system of claim 6, wherein
the information which is used for generation of the learned model and which is on the operation of the store includes information on a specific product category in a target time period in the past in a specific relationship with the present.

11. The store supporting system of claim 1, wherein
the learned model is corrected based on result data of the target store.

12. The store supporting system of claim 1, wherein
the recommendation information includes recommended product information on a plurality of recommended products and recommendation rank order information on rank orders of the plurality of recommended products.

13. The store supporting system of claim 12, wherein
when the recommended products include an unhandled product unhanded in the target store, a rank order of the unhandled product is determined based on similarity between the unhandled product and a handled product in the target store.

14. The store supporting system of claim 1, wherein
the estimation unit is configured to further use, as input information, a restriction condition which defines a restriction on the operation information, in addition to the operation information.

15. The store supporting system of claim 14, wherein
the restriction condition includes a condition relating to a size of each of a plurality of products.

16. The store supporting system of claim 14, wherein
the restriction condition includes a condition which defines at least one of a maximum value or a minimum value of a SKU number or a number of items in one product category.

17. A learning device configured to generate a learned model to be used in a store supporting system, the store supporting system being configured to estimate a management index by using, as input information, at least operation information on operation of a target store which is a specific store, the management index relating to management of the target store, the learning device being configured to generate the learned model by machine learning with data which is input as training data to the learning device and which includes information on operation of a store and an index relating to management of the store.

18. A store supporting method comprising:
an estimation process of estimating; based on a learned model, a management index by using at least operation information as input information, the learned model being generated by machine learning with data, as training data, including information on operation of a store and an index relating to management of the store, the operation information being information on operation of a target store which is a specific store, the management index relating to management of the target store; and
an output process of obtaining, based on a result of estimation in the estimation process, recommendation information and outputting the recommendation information, the recommendation information being information relating to the operation of the target store and being recommendable for the target store.

19. (canceled)

20. A non-transitory storage medium storing a program which is configured to cause one or more processors to execute the store supporting method of claim 18.
